(19) United States
(12) Patent Application Publication
(10) Pub. No.: US 2024/0095300 A1
(43) Pub. Date: Mar. 21, 2024

(54) SOLUTION FINDING DEVICE, SOLUTION FINDING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/517,147

(22) Filed: Nov. 22, 2023

Related U.S. Application Data
(63) Continuation of application No. PCT/JP2022/017778, filed on Apr. 14, 2022.

(30) Foreign Application Priority Data
May 24, 2021 (JP) 2021-087125

(51) Int. Cl. G06F 17/11

(52) U.S. Cl. CPC G06F 17/11

(57) ABSTRACT

A 0-1 combinatorial-optimization-problem is solved under constraint-conditions expressed using inequality expressions. A solution-finding device includes an updating-unit and an output-unit. For each of plural elements associated with first- and second-variables, the updating-unit sequentially updates, for each unit-time between initial-timing and end-timing, the first-variable and the second-variable alternatively. The output-unit outputs the solution of the 0-1 combinatorial-optimization-problem based on the first-variable of each of the plural elements at the end-timing. During the updating operation for each unit-time, for each of one or more constraint-conditions, when the inequality expression in which the first-variable corresponding to each of the plural discrete variables is substituted is unsatisfied; the updating-unit subtracts, from the second-variable of each of the plural elements, a correction value corresponding to the component of the element corresponding to the distance from the boundary of the inequality expression to positions identified by the plural elements.

### CROSS-REFERENCE TO RELATED APPLICATIONS

This application is a continuation of PCT International Application No. PCT/JP2022/017778 filed on Apr. 14, 2022 which claims the benefit of priority from Japanese Patent Application No. 2027-087125, filed on May 24, 2021, the entire contents of which are incorporated herein by reference.

### FIELD

An embodiment of the present disclosure relates to a solution finding device, a solution finding method, and a computer program product.

### BACKGROUND

Conventionally, as a method for solving the Ising problem under the constraints attributed to a linear inequality expression, a formulated method using slack variables is known. In this method, if a constant term in linear inequality is Wₘ, then a penalty term expressed using W number of slack variables (where W represents a natural number) is added to the objective function, and the Ising problem is solved. Thus, according to this method, if N number of decision variables are included in the objective function, then the Ising problem including N+W number of Ising spins is solved. Alternatively, for example, if the Ising problem is to be solved under the constraints of M number of linear inequality expressions; then, according to this method, the Ising problem including N+{W₁+ . . . +Mₘ+ . . . +W_{M}} number of Ising spins is solved. Herein, Mm represents the constant term of the m-th linear inequality expression from among M number of linear inequality expressions, and is a natural number.

As far as the portfolio optimization problem in equity is concerned; in order to avoid the risks, the investment percentages of stocks are treated as the decision variables and, in numerous cases, the portfolio optimization problem is solved under the constraint condition that the total obtained by multiplying a weight for each of the decision variables is equal to or smaller than the upper limit value. The constraint condition is expressed according to the linear inequality expression given below.

xA1·ωA2+xA2·ωA2+ . . . +xSm·ωSm+ . . . ≤Wm

In this formula, Wₘ represents the upper limit value. Moreover, x_{A1} represents the decision variable for the investment percentage of a stock A to be, for example, 1%. Furthermore, x_{A2} represents the decision variable for the investment percentage of the stock A to be, for example, 2%. Thus, x_{Ss} represents the decision variable for the investment percentage of a stock S to be, for example, s %. Moreover, ω_{A1}, ω_{A2}, and ω_{Sm} represent the weights.

Thus, in the portfolio optimization problem in equity, a plurality of stocks is grouped according to each business type or each company size, and the abovementioned constraint condition is set for each group. For example, the Tokyo Stock Exchange handles approximately 2000 stocks. Moreover, the Tokyo Stock Exchange classifies approximately 2000 stocks into 33 business types and three company sizes. Thus, approximately 2000 stocks handled in the Tokyo Stock Exchange can be classified into a total of 99 groups of 33 business types x three sizes.

If the investment percentage of a single stock is discretized into 100 stages from 1% to 100% and if the portfolio optimization problem is solved with respect to the 2000 stocks handled in the Tokyo Stock Exchange, then the number of decision variables included in the objective function becomes 200000.

In that regard, assume that the constraint condition attributed to a linear inequality expression is set with respect to all of the 99 groups. When the upper limit value (Wₘ) is discretized in 100 stages and is formulated using slack variables, the number of slack variables is 99000. Hence, if the portfolio optimization problem is to solved for which the constraint condition attributed to a linear inequality expression is set for all of the 99 groups, then the Ising problem needs to be solved for 200000+99000=299000 Ising spins.

In this way, in the case of solving the portfolio optimization problem by performing formulation using slack variables; in the example of the Tokyo Stock Exchange, the number of Ising spins increases by about 50% as compared to the case in which no constraint conditions are set. In the case of using a solver and the like to solve the Ising problem, if the number of Ising spins increases, it results in an increase in the amount of computation and the time of computation thereby increasing a cost for finding a solution.

### BRIEF DESCRIPTION OF THE DRAWINGS

FIG. 1 is a diagram illustrating a bifurcation phenomenon occurring in a simulated bifurcation algorithm.

FIG. 2 is a diagram illustrating a functional configuration of a solution finding device according to an embodiment.

FIG. 3 is a flowchart for explaining a first example of the flow of operations performed by an updating unit.

FIG. 4 is a flowchart for explaining a second example of the flow of operations performed by the updating unit.

FIG. 5 is a flowchart for explaining a first example of the flow of operations performed during constraint processing.

FIG. 6 is a flowchart for explaining a second example of the flow of operations performed during constraint processing.

FIG. 7 is a flowchart for explaining a third example of the flow of operations performed during constraint processing.

FIG. 8 is a diagram illustrating a configuration of an information processing system.

FIG. 9 is a diagram illustrating a configuration of a management server.

FIG. 10 is a diagram illustrating the data stored in a memory unit.

FIG. 11 is a diagram illustrating a configuration of a compute server.

FIG. 12 is a diagram illustrating the data stored in a storage.

### DETAILED DESCRIPTION

It is an objective of the present disclosure to provide a solution finding device, a solution finding method, and a computer program product that enable solving a 0-1 combinatorial optimization problem under one or more constraint conditions that are expressed using inequality expressions.

A solution finding device according to an embodiment solves a 0-1 combinatorial optimization problem under one or more constraint conditions that are expressed using inequality expressions in which a plurality of discrete variables included in the 0-1 combinatorial optimization problem is used. The solution finding device includes an updating unit and an output unit. The updating unit, for each of a plurality of elements associated with a first variable and a second variable, sequentially updates, for each unit time between initial timing and end timing, the first variable and the second variable alternatively. The output unit outputs a solution of the 0-1 combinatorial optimization problem based on the first variable of each of the plurality of elements at the end timing. The plurality of elements correspond to the plurality of discrete variables. Each of the first variable and the second variable is expressed as a real number. During an updating operation performed for the each unit time, for each of the plurality of elements, the updating unit updates the first variable based on the second variable. For each of the plurality of elements, the updating unit updates the second variable based on the first variable. For each of the one or more constraint conditions, when the inequality expression in which the first variable corresponding to each of the plurality of discrete variables is substituted is not satisfied, the updating unit subtracts, from the second variable of each of the plurality of elements, a correction value that corresponds to a component of an element corresponding to a distance from a boundary of the inequality expression to positions identified by the plurality of elements.

### 0-1 Combinatorial Optimization Problem

An Ising machine represents an example of the device used in solving the Ising problem. An Ising machine calculates the energy in the ground state of the Ising model. Before now, the Ising model has been mainly used as a model for ferromagnetic substances or a model for the phase transition phenomenon. However, in recent years, the Ising model is being increasingly used for solving 0-1 combinatorial optimization problems. Formula (1) expresses the energy of the Ising model.

$${E}_{ising} = - {\sum }_{i = 1}^{N} {h}_{i} {s}_{i} - \frac{1}{2} {\sum }_{i = 1}^{N} {\sum }_{j = 1}^{N} {J}_{i , j} {s}_{i} {s}_{j} \qquad ( 1 )$$

Herein, sᵢ and sⱼ represent spins. A spin is a

binary variable that takes either +1 or −1 as the value. Moreover, sᵢ represents the i-th spin, and sⱼ represents the j-th spin. Furthermore, i and j are integers equal to or greater than “1” and equal to or smaller than N. Moreover, N represents the number of spins and is an integer equal to or greater than “2”. Furthermore, hi represents the local magnetic field acting on the i-th spin. Moreover, J represents a matrix of coupling coefficients indicating the force acting among the spins. Herein, J represents a real symmetric matrix in which diagonal elements are “0”. Furthermore, J_{i, j} represents the i-th row and the j-th column in the matrix J. Thus, J_{i, j} represents a coupling coefficient indicating the force acting between the i-th spin and the j-th spin.

In the Ising machine, the energy E_{Ising} expressed in Formula (1) is treated as the objective function, and a solution for minimizing the energy E_{Ising} is calculated. The solution (S₁, S₂, . . . , S_{N}) calculated in the Ising model for minimizing the energy E_{Ising} is called the optimum solution. However, the solution calculated in the Ising model need not be the optimum solution, and the energy E_{Ising} can be an approximate solution close to the optimum solution. That is, the Ising problem is not limited to calculating the optimum solution, and can be a problem for calculating an approximate solution.

Meanwhile, a 0-1 combinatorial optimization problem in which a quadratic function of discrete variables (bits) that take either +1 or −1 as the value is treated as the objective function is called the 0-1 quadratic programming problem. A discrete variable (bit) is converted into the spin sᵢ according to the computation of (1+sᵢ)/2. That is, a 0-1 quadratic programming problem can be said to be equivalent to the Ising problem expressed in Formula (1). Thus, a 0-1 quadratic programming problem can be converted into the Ising problem, and the solution can be calculated according to an Ising machine.

For example, an Ising machine is implemented in hardware using a quantum annealer, a coherent Ising machine, or a quantum bifurcation machine. A quantum annealer performs quantum annealing using a superconducting circuit. A coherent Ising machine uses the oscillation phenomenon of a network configured with optical parametric oscillators. A quantum bifurcation machine uses the quantum-mechanical bifurcation phenomenon in a network of parametric oscillators having the Kerr effect. Such an Ising machine implemented in hardware likely enables achieving a significant reduction in the computation time. However, there are also issues such as difficulty in achieving a large scale and achieving stable operation.

Regarding the Ising problem, the solution can be calculated also using a digital computer that has become widely popular. As compared to a quantum annealer, a coherent Ising machine, or a quantum bifurcation machine; a digital computer enables achieving operation on a large scale and with stability. Meanwhile, simulated annealing (SA) represents an exemplary algorithm meant for solving the Ising problem using a digital computer. However, simulated annealing is a sequential-update-type algorithm in which each variable is sequentially updated. Hence, speeding up the computation by implementing parallelization is difficult to achieve.

In Non Patent Literature 2, a simulated bifurcation algorithm is proposed as an algorithm for solving a 0-1 combinatorial optimization problem. The simulated bifurcation algorithm is capable of using the Ising model and solving, at a high speed, a large-scale 0-1 combinatorial optimization problem in a digital computer. The simulated bifurcation algorithm is capable of solving, at a high speed, a large-scale 0-1 combinatorial optimization problem also in a Central Processing Unit (CPU), or in a microprocessor, or in a Graphics Processing Unit (GPU), or in a Field-Programmable Gate Array (FPGA), or in an Application Specific Integrated Circuit (ASIC), or in a combination of such circuits.

### Simulated Bifurcation Algorithm

In the simulated bifurcation algorithm, variables xᵢ and yᵢ corresponding to N number of elements are used. The variable xᵢ is sometimes also called a first variable, and the variable yᵢ is sometimes also called a second variable.

In the simulated bifurcation algorithm, each of the N number of elements represents a virtual particle. Herein, the N number of elements correspond to the N number of spins in the Ising problem. Thus, the N number of elements correspond to the N number of discrete variables (bits) in a combinatorial optimization problem. The variable (xᵢ) and the variable yᵢ is a continuous variable expressed as a real number. The variable xᵢ represents the position of the i-th particle from among N number of particles. The variable yᵢ represents the amount of motion of the i-th particle. Herein, N is an integer equal to or greater than “2”. Moreover, i is an integer equal to or smaller than N, and represents the index for identifying each of the N number of elements.

In the simulated bifurcation algorithm, regarding the N number of variables xᵢ and the N number of variables yᵢ, a simultaneous ordinary differential equation given below in Formula (2) is numerically solved.

$$\frac{{dx}_{i}}{dt} - \frac{\partial H}{\partial {y}_{i}} = {Dy}_{i} \qquad ( 2 )$$

$$\frac{{dy}_{i}}{dt} = \frac{\partial H}{\partial {x}_{i}} = \{ - D + p ( t ) - {Kx}_{i}^{2} \} {x}_{i} + {f}_{i}$$

Herein, H represents the Hamiltonian as given below in Formula (3).

$$H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} - c ( {h}_{i} {x}_{i} α ( t ) + \frac{1}{2} {\sum }_{j = 1}^{N} {J}_{i , j} {x}_{i} {x}_{j} ) ] \qquad ( 3 )$$

The coefficient D is a predetermined constant

number and corresponds to detuning. The coefficient p(t) corresponds to pumping amplitude and undergoes monotonic increase according to the update count during the calculation performed based on the simulated bifurcation algorithm. Meanwhile, “t” represents a variable indicating the timing. The coefficient p(t) can have the initial value set to “0”. The coefficient K represents a predetermined constant number and corresponds to a positive Kerr coefficient. Herein, the coefficient K can be set to “0”.

Moreover, fᵢ represents the external force and is expressed according to Formula (4) given below.

$${f}_{i} = - {cz}_{i} \qquad ( 4 )$$

$${z}_{i} = - {h}_{i} α ( t ) - {\sum }_{j = 1}^{N} {J}_{i , j} {x}_{j}$$

In Formula (4), zᵢ represents an Formula in which the mathematical formula given in the parentheses in Formula (3) is partially differentiated by the variable xᵢ. The mathematical formula given in the parentheses in Formula (3) corresponds to the energy E_{Ising} of the Ising model.

Herein, “c” represents a coefficient that, for

example, can be a constant number set before performing the computation. Moreover, α(t) is a coefficient that becomes greater along with the coefficient p(t).

In the simulated bifurcation algorithm, after the value of the coefficient p(t) has been increased from the initial value (for example, 0) to a predetermined value; based on the sign of the variable xᵢ, the value of the spin sᵢ is calculated. In the simulated bifurcation algorithm, for example, when x>0 holds true, the value of the spin sᵢ is calculated using a signum function sgn(xᵢ)=1; and, when x<0 holds true, the value of the spin sᵢ is calculated using a signum function sgn(xᵢ)=−1.

### Operation of Simulated Bifurcation Algorithm

In the simulated bifurcation algorithm, the differential equations given in Formula (2), Formula (3), and Formula (4) are solved according to the symplectic Euler method.

In the case of implementing the symplectic Euler method, the differential Formulas given in Formula (2), Formula (3), and Formula (4) are rewritten as discrete recurrence formulae as given below in Formula (5) or Formula (6).

xᵢ(t+Δt)=xᵢ(t)+Dyᵢ(t)Δt

yᵢ(t+Δt)=yᵢ(t)+[{−D+p(t+Δt)−Kxᵢ²(t+Δt)}xᵢ(t+Δt)+fᵢ(t+Δt)]Δt

fᵢ(t+Δt)=−czᵢ(t+Δt)

yᵢ(t+Δt)=yᵢ(t)+[{−D+p(t)−Kxᵢ²(t)}xᵢ(t)+fᵢ(t)]Δt

xᵢ(t+Δt)=xᵢ(t)+Dyᵢ(t+Δt)

fᵢ(t)=−cZᵢ(t)

Herein, “t” represents the timing. Moreover, Δt represents the unit time (i.e., the time stamp or the time pitch width).

In the case of executing the simulated bifurcation algorithm, based on the algorithm given Formula (5) or Formula (6), an electronic circuit such as a digital computer or an FPGA sequentially updates, for each unit time from the initial timing, each of the N number of variables xᵢ and each of the N number of variables yᵢ, and updates the variables xᵢ and yᵢ alternatively. Then, the electronic circuit such as the digital computer or the FPGA binarizes the values of N number of variables xᵢ at the end timing using a signum function, and outputs the values of N number of spins.

Meanwhile, Formula (5) and Formula (6) are expressed using the timing t and the unit time Δt in order to indicate the correspondence relationship with the differential equation. However, in the case of implementing the symplectic Euler method in an electronic circuit such as a digital computer or an FPGA, the algorithm meant for computing Formula (5) and Formula (6) need not include the unit time Δt. For example, if the timing t is not included as an explicit parameter, then the algorithm meant for computing Formula (5) and Formula (6) includes updating xᵢ(t+Δt) to xᵢ(t). That is, in the algorithm meant for computing Formula (5) and Formula (6), “t” is treated as the parameter for identifying the pre-updating variables and “t+Δt” is treated as the parameter for identifying the post-updating variables. The same is the case regarding an algorithm explained below in which Formula (5) and Formula (6) are enhanced.

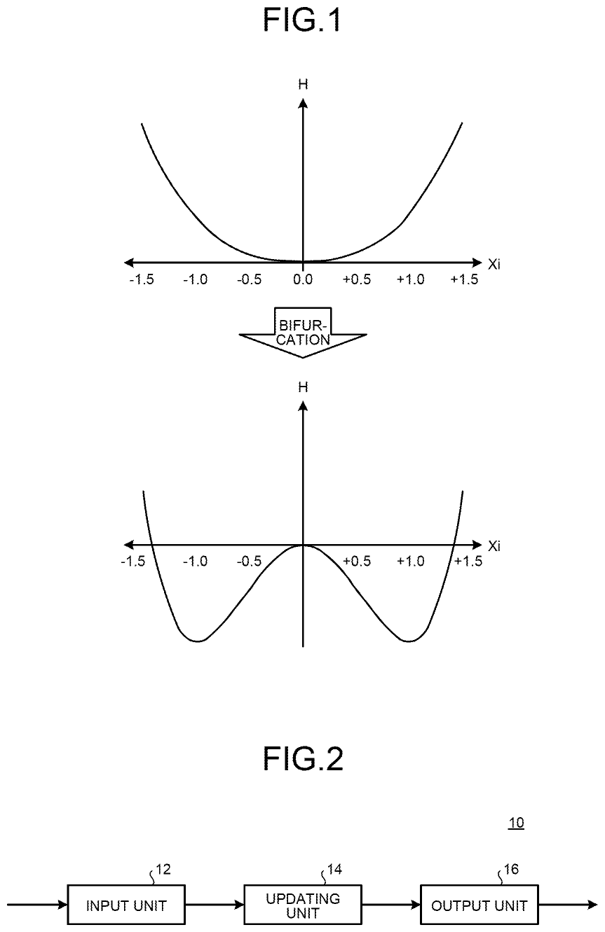

FIG. 1 is a diagram illustrating the bifurcation phenomenon of the variable xᵢ in the case in which an optimization problem is solved according to the simulated bifurcation algorithm. When an optimization problem is solved according to the simulated bifurcation algorithm, accompanying the changes in the parameters of the system, a bifurcation phenomenon occurs in which there is transition from the system having only one stable operation state to the system having two stable operation states. As illustrated in FIG. 1, as the bifurcation phenomenon progresses, the variables xᵢ concentrate in the vicinity of −1 or +1 and spread in the region smaller than −1 or in the region greater than +1.

### Enhanced Algorithm

The present inventor(s) enhanced the abovementioned simulated bifurcation algorithm and, under one or more constraint conditions expressed using inequality expressions, invented an enhanced algorithm for solving a 0-1 combinatorial optimization problem.

In the enhanced algorithm, the simultaneous ordinary differential equation given in Formula (2) is numerically solved using the Hamiltonian given below in Formula (7) instead of using the Hamiltonian given earlier in Formula (3).

$$H = {\sum }_{i = 1}^{N} [ \frac{D}{2} ( {x}_{i}^{2} + {y}_{i}^{2} ) - \frac{p ( t )}{2} {x}_{i}^{2} + \frac{K}{4} {x}_{i}^{4} - c ( {h}_{i} {x}_{i} α ( t ) + \frac{1}{2} {\sum }_{j = 1}^{N} {J}_{i , j} {x}_{i} {x}_{j} ) ] + {\sum }_{m = 1}^{M} {G}_{m} ( {x}_{1} , {x}_{2} , ⋯ , {x}_{N} ) \qquad ( 7 )$$

Herein, Gₘ represents the penalty item corresponding to the m-th constraint condition from among one or more constraint conditions. Each of one or more constraint conditions is expressed using an inequality expression that includes a plurality of discrete variables included in the objective function. For example, an inequality expression either can be a linear inequality expression that includes the first-order terms of a plurality of discrete variables, or can be a quadratic inequality expression that includes the second-order terms of a plurality of discrete variables.

When the penalty term satisfies the corresponding inequality expression, “0” is added as energy to the Hamiltonian. However, if the penalty term does not satisfy the corresponding inequality expression, then positive energy is added to the Hamiltonian. More particularly, G m represents a function that adds energy to the Hamiltonian in proportion to the distance from the boundary of the inequality expression, which indicates the constraint condition, to the position identified based on the N number of elements. The boundary of an inequality expression represents the boundary at which the inequality expression may or may not be satisfied. That is, the boundary of an inequality expression is expressed as an equation in which the inequality sign in the inequality expression is replaced by an equality sign.

Subsequently, in the enhanced algorithm, the symplectic Euler method is implemented and the simultaneous ordinary differential equation is solved using a discrete recurrence formula as given below in Formula (8) or Formula (9)

$${x}_{i} ( t + Δ t ) = {x}_{i} ( t ) + {Dy}_{i} ( t ) Δ t \qquad ( 8 )$$

$${y}_{i} ( t + Δ t ) = {y}_{i} ( t ) + [ \{ - D + p ( t + Δ t ) - {Kx}_{i}^{2} ( t + Δ t ) \} {x}_{i} ( t + Δ t ) + {f}_{i} ( t + Δ t ) ] Δ t - Δ t {\sum }_{m = 1}^{M} \frac{\partial {G}_{m}}{\partial {x}_{i}}$$

$${f}_{i} ( t + Δ t ) = - {cZ}_{i} ( t + Δ t )$$

$${y}_{i} ( t + Δ t ) = {y}_{i} ( t ) + [ \{ - D + p ( t ) - {Kx}_{i}^{2} ( t ) \} {x}_{i} ( t ) + {f}_{i} ( t ) ] Δ t - Δ t {\sum }_{m = 1}^{M} \frac{\partial {G}_{m}}{\partial {x}_{i}} \qquad ( 9 )$$

$${x}_{i} ( t + Δ t ) = {x}_{i} ( t ) + {Dy}_{i} ( t + Δ t )$$

$${f}_{i} ( t ) = - {cZ}_{i} ( t )$$

As compared to the recurrence formulae given earlier in Formulas (5) and (6); in the recurrence formulae given in Formulas (8) and (9), the computation formula for the second variable (yᵢ(t+Δt)) is different. More particularly, the recurrence formulae expressed in Formulas (8) and (9) differ in the way that, in the computation formula for the second variable (yᵢ(t+Δt)), a value obtained by multiplying Δt and the total of the partial differentiation values regarding xᵢ of the penalty term (Gₘ) of each of one or more inequality expressions is subtracted.

In each of one or more inequality expressions, the partial differentiation value is equivalent to the component of the corresponding element present at the distance from the boundary of the concerned inequality expression to the position identified based on N number of elements. The partial differentiation value increases in proportion to the size of the component of the corresponding element at the distance from the boundary of the concerned inequality expression to the position identified based on N number of elements.

However, when the corresponding inequality expression is satisfied, the penalty term becomes “0”. Thus, when the N number of elements satisfy the inequality expression, the partial differentiation value of each of one or more inequality expressions becomes “0”.

In the simulated bifurcation algorithm, while the variable t indicating the timing is increased for each unit time (Δt), a plurality of first variables (xᵢ) and a plurality of second variables (yᵢ) are updated alternatively. Thus, in the simulated bifurcation algorithm, for each unit time (Δt), it becomes possible to determine whether or not each of one or more constraint conditions satisfies the inequality expression.

In that regard, in the enhanced algorithm, for each unit time (Δt), after a plurality of second variables (yᵢ) is updated, it is determined whether or not each of one or more constraint conditions satisfies the inequality expression in which each of a plurality of discrete variables is substituted with the corresponding first variable (xᵢ). In the enhanced algorithm, for each unit time (Δt), if it is determined that each of one or more constraint conditions does not satisfy the inequality expression in which each of a plurality of discrete variables is substituted with the corresponding first variable, then the corresponding correction value is subtracted from each of a plurality of second variables (yᵢ). That is, in the enhanced algorithm, for each unit time (Δt), if each of one or more constraint conditions does not satisfy the inequality expression in which each of a plurality of discrete variables is substituted with the corresponding first variable; from each of a plurality of second variables (yᵢ), a correction value is subtracted that corresponds to the component of the concerned element present at the distance from the boundary of the inequality expression to the position identified based on a plurality of elements.

As a result, in the enhanced algorithm, in order to ensure that, for each unit time (Δt), a plurality of first variables (xᵢ) and a plurality of second variables (yᵢ) satisfy each of one or more constraint conditions, a plurality of first variables (xᵢ) and a plurality of second variables (yᵢ) can be corrected. As a result, in the enhanced algorithm, it becomes possible to increase the probability of a plurality of first variables (xᵢ) satisfying all of one or more constraint conditions at the end timing (t=T).

In such an enhanced algorithm, even in the case of solving a 0-1 combinatorial optimization problem under one or more constraint conditions expressed using inequality expressions, the solution can be obtained according to the same number of variables as the number of variables in the case in which the constraint conditions are not set. Thus, in such an enhanced algorithm, a 0-1 combinatorial optimization problem can be easily solved under one or more constraint conditions, which are expressed using inequality expressions, without having to set slack variables.

### First Example of Penalty Term and Partial Differentiation Value When Constraint Condition is Linear Inequality Expression

Of one or more constraint conditions, one constraint condition is expressed using a linear inequality expression. For example, in the enhanced algorithm, a 0-1 combinatorial optimization problem is solved under the constraint of M number of linear inequality expressions (where M is an integer equal to or greater than “1”). In that case, from among one or more constraint conditions, the m-th constraint condition is expressed as given below in Formula (10).

$${{\sum }_{i = 1}}^{N} {ω}_{m , i} \cdot {x}_{i} ≦ {W}_{m} \qquad ( 10 )$$

In Formula (10), m represents an integer equal to

or greater than “1” and equal to or smaller than M. Moreover, in Formula (10), xᵢ represents the i-th discrete variable. Furthermore, in Formula (10), xⱼ represents the j-th discrete variable. Moreover, ω_{m, i} represents a coefficient that is multiplied to the i-th discrete variable. Furthermore, Wₘ represents a predetermined constant number.

When a constraint condition is expressed using a linear inequality expression, the penalty term Gₘ can be expressed as given below in Formula (11).

$${G}_{m} = \{ \begin{matrix}0 & if {S}_{m} ≦ {W}_{m} \\ {A}_{m} \cdot {\vert {S}_{m} - {W}_{m} \vert}^{k} & if {S}_{m} > {W}_{m}\end{matrix} \qquad ( 11 )$$

Herein, Aₘ represents a predetermined constant number set with respect to the m-th constraint condition. Moreover, “k” represents an integer equal to or greater than “1”. For example, “k” can be set to “2”.

Furthermore, Sₘ represents the value obtained when, in each of a plurality of discrete variables in the functions excluding the constant term (Wₘ) present in a linear inequality expression, the corresponding first variable (xᵢ) is substituted. More particularly, in the case of applying the recurrence formula given in Formula (8), the value S. is expressed as given below in Formula (12). Alternatively, in the case of applying the recurrence formula given in Formula (9), the value Sₘ is expressed as given below in Formula (13).

$${S}_{m} = {\sum }_{i = 1}^{N} {ω}_{m , i} \cdot {x}_{i} ( t + Δ t ) \qquad ( 12 )$$

$${S}_{m} = {\sum }_{i = 1}^{N} {ω}_{m , i} \cdot {x}_{i} ( t ) \qquad ( 13 )$$

In that case, the partial differentiation value is expressed as given below in Formula (14).

$$\frac{\partial G}{\partial {x}_{i}} = \{ \begin{matrix}0 & if & {S}_{m} ≦ {W}_{m} \\ {A}_{m} \cdot k \cdot \vert {S}_{m} & {- {W}_{m} \vert}^{k - 1} \cdot {ω}_{m , i} & {S}_{m} > {W}_{m}\end{matrix} \qquad ( 14 )$$

In that regard, when a constraint condition is expressed using a linear inequality expression; in the enhanced algorithm, for each unit time (Δt), after a plurality of second variables (yᵢ) is updated, it is determined whether or not a linear inequality expression in which the first variable (xᵢ) corresponding to each of a plurality of discrete variables is substituted is satisfied. Then, in the enhanced algorithm, for each unit time (Δt), if the corresponding linear inequality expression is not satisfied; then, a correction value obtained by multiplying Δt denoting the unit time and the partial differentiation value expressed in Formula (14) is subtracted from each of a plurality of second variables (yᵢ).

Thus, according to the enhanced algorithm in which the abovementioned operations are performed, using the same number of variables as the number of variables in the case in which no constraint conditions are set, a 0-1 combinatorial optimization problem can be easily solved under the constraint conditions expressed using linear inequality expressions.

### Second Example of Penalty Term and Partial Differentiation Value of a Constraint Condition Being a Linear Inequality Expression

If the constant number Aₘ is large, then the partial differentiation value given in Formula (14) may become unstable because of accumulation of computational errors. In that regard, in the enhanced algorithm, when the constraint conditions are linear inequality expressions, the partial differentiation value given in Formula (15) can be used. That is, in the enhanced algorithm, for each unit time (Δt), when the corresponding linear inequality expression is not satisfied, a correction value obtained by multiplying Δt denoting the unit time and the partial differentiation value expressed by Formula (15) is subtracted from each of a plurality of second variables (yᵢ).

$$\frac{\partial G}{\partial {x}_{i}} = \{ \begin{matrix}0 & if & {S}_{m} ≦ {W}_{m} \\ ( {A}_{m} \cdot k \cdot \vert {S}_{m} - {{W}_{m} \vert}^{k - 1} + & {B}_{m} \cdot {E}_{m} ) {ω}_{m , i} & {S}_{m} > {W}_{m}\end{matrix} \qquad ( 15 )$$

Herein, Bₘ is equal to or smaller than “0” and equal to or greater than “1” and represents a coefficient predetermined with respect to the m-th constraint condition. Moreover, Eₘ represents the value obtained when, in each of a plurality of discrete variables in the functions excluding the constant term (Wₘ) present in a linear inequality expression, the corresponding second variable (yᵢ) is substituted. More particularly, in the case of applying the recurrence formula given in Formula (8) or Formula (9), the value Eₘ is expressed as given below in Formula 16.

$${E}_{m} = {\sum }_{i = 1}^{N} {ω}_{m , i} \cdot y ( t + Δ t ) \qquad ( 16 )$$

Herein, the value Eₘ represents the slope of the direction identified according to a plurality of elements with respect to the boundary of the linear inequality expression. Thus, when the partial differentiation value given in Formula (15) is used, the correction value corresponds to the value obtained as a result of adding the component of the element at the distance from the boundary of the inequality expression to the position identified based on a plurality of elements to the component of the element corresponding to the slope of the direction identified by a plurality of elements with respect to the boundary of the inequality expression. As a result, in the enhanced algorithm, even if the component corresponding to the distance becomes unstable due to a large value of Aₘ, the correction value can be stabilized.

### Penalty Term and Partial Differentiation Value When Constraint Condition is Quadratic Inequality Expression

Of one or more constraint conditions, one constraint condition can be expressed using a quadratic inequality expression. In that case, the constraint condition is expressed as given below in Formula (17).

$${\sum }_{i = 1}^{N} {\sum }_{j = 1}^{N} {Q}_{i , j} \cdot {x}_{i} \cdot {x}_{j} ≦ q \qquad ( 17 )$$

In Formula (17), xᵢ represents the i-th discrete variable. Moreover, in Formula (17), xⱼ represents the j-th discrete variable. Furthermore, Q_{i,j} represents the value at the i-th row and the j-th column included in an N×N positive-semidefinite matrix. Moreover, q represents a predetermined constant number.

When a constraint condition is expressed using a quadratic inequality expression, the penalty item G can be expressed as given below in Formula (18).

$$G = \{ \begin{matrix}0 & if & S ≦ q \\ A \cdot & {\vert S - q \vert}^{k} & S > q\end{matrix} \qquad ( 18 )$$

Herein, “A” represents a coefficient predetermined with respect to the constraint condition expressed using a quadratic inequality expression. Moreover, “k” represents an integer equal to or greater than “1”. For example, “k” can be set to “2”.

Furthermore, “S” represents the value obtained

when, in each of a plurality of discrete variables in the functions excluding the constant term (q) present in a quadratic inequality expression, the corresponding first variables (xᵢ and xⱼ) are substituted. More particularly, in the case of applying the recurrence formula given in Formula (8), the value S is expressed as given below in Formula (19). Alternatively, in the case of applying the recurrence formula given in Formula (9), the value S is expressed as given below in Formula (20).

$$S = {\sum }_{i = 1}^{N} {\sum }_{j = 1}^{N} {Q}_{i , j} \cdot {x}_{i} ( t + Δ t ) \cdot {x}_{j} ( t + Δ t ) \qquad ( 19 )$$

$$S = {\sum }_{i = 1}^{N} {\sum }_{j = 1}^{N} {Q}_{i , j} \cdot {x}_{i} ( t ) \cdot {x}_{j} ( t ) \qquad ( 20 )$$

In that case, in the case of applying the recurrence formula given in Formula (8), the partial differentiation value is expressed as given below in Formula (21). Alternatively, in the case of applying the recurrence formula given in Formula (9), the partial differentiation value is expressed as given below in Formula (22).

$$\frac{\partial G}{\partial {x}_{i}} = \{ \begin{matrix}0 & if & S ≦ q \\ A \cdot k \cdot \vert S & {- q \vert}^{k - 1} \cdot 2 \cdot {\sum }_{j = 1}^{N} {Q}_{i , j} \cdot {x}_{i} ( t + Δ t ) if & S > q\end{matrix} \qquad ( 21 )$$

$$\frac{\partial G}{\partial {x}_{i}} = \{ \begin{matrix}0 & if & S ≦ q \\ A \cdot k \cdot & {\vert S - q \vert}^{k - 1} \cdot 2 \cdot {\sum }_{j = 1}^{N} {Q}_{i , j} \cdot {x}_{i} ( t ) if & S > q\end{matrix} \qquad ( 22 )$$

In that regard, when a constraint condition is expressed using a quadratic inequality expression, in the enhanced algorithm; for each unit time (Δt), after a plurality of second variables (yᵢ) is updated, it is determined whether or not a quadratic inequality expression in which the first variables (xᵢ and xⱼ) corresponding to each of a plurality of discrete variables is substituted is satisfied. In the enhanced algorithm, for each unit time (Δt), if the corresponding quadratic inequality expression is not satisfied, then a correction value obtained by multiplying Δt denoting the unit time and the partial differentiation value expressed by Formula (21) or Formula (22) is subtracted from each of a plurality of second variables (yᵢ).

In an Ising model, solving a 0-1 combinatorial problem under the constraint conditions expressed using quadratic inequality expressions is a difficult task. In contrast, in the enhanced algorithm, under the constraint conditions expressed using quadratic inequality expressions, a 0-1 combinatorial optimization problem can be solved with ease.

Meanwhile, even when one or more constraint conditions include constraint conditions expressed using linear inequality expressions and constraint conditions expressed using quadratic inequality expressions, a 0-1 combinatorial optimization problem can still be solved according to the enhanced algorithm. Moreover, in the enhanced algorithm, one or more constraint conditions can include the constraint conditions expressed using only linear inequality expressions. Furthermore, in the enhanced algorithm, a 0-1 combinatorial optimization problem can be solved under only one constraint condition expressed using a quadratic inequality expression.

### Functional Block Configuration

FIG. 2 is a diagram illustrating a functional configuration of a solution finding device 10 according to the present embodiment.

The solution finding device 10 implements the enhanced algorithm and solves a 0-1 combinatorial optimization problem under one or more constraint conditions expressed using inequality expressions. The solution finding device 10 is implemented using an information processing device such as a computer; or using a computer system in which a plurality of computers or servers communicates with each other via a network; or using a PC cluster in which a plurality of computers performs information processing in coordination. Alternatively, the solution finding device 10 is implemented using an electronic circuit such as a CPU, a microprocessor, a GPU, an FPGA, an ASIC, or a circuit configured by combining such circuits.

The solution finding device 10 includes an input unit 12, an updating unit 14, and an output unit 16 as a functional configuration.

The input unit 12 receives, from an external device, information to be used in defining the objective function of a 0-1 combinatorial optimization problem (for example, N, J, and h) and information indicating the coefficients required in executing the enhanced algorithm (for example, D, c, Δt, T, p(t), and α(t)). Moreover, the input unit 12 receives, from an external device, information to be used in defining one or more constraint conditions (for example, ω_{m, i}, Wₘ, Q_{i, j}, and q) and information required in executing constraint processing (for example, Aₘ, k, Bₘ, and A). Then, the input unit 12 sends the received information to the updating unit 14.

The updating unit 14 implements the enhanced algorithm and, for each of a plurality of elements associated with the first variables (xᵢ) and the second variables (yᵢ), sequentially updates the first variables (xᵢ) and the second variables (yᵢ) alternatively for each unit time (Δt) from the initial timing (t=0) to the end timing (t=T).

Based on the first variables (xᵢ) of each of a

plurality of elements at the end timing (t=T), the output unit 16 outputs the solution of the 0-1 combinatorial optimization problem. For example, for each of a plurality of elements at the end timing, the output unit 16 calculates the values of discrete variables by binarizing the first variables (xᵢ) using a preset threshold value. Then, the output unit 16 outputs the calculated values of the discrete variables as the solution of the 0-1 combinatorial optimization problem.

Herein, a plurality of elements correspond to a plurality of discrete variables of the 0-1 combinatorial optimization problem. Moreover, each of the first variables (xᵢ) and the second variables (yᵢ) is expressed as a real number.

During the updating operation performed for each unit time, for each of a plurality of elements, the updating unit 14 updates the first variables (xᵢ) based on the second variables (yᵢ). Moreover, during the updating operation performed for each unit time, for each of a plurality of elements, the updating unit 14 updates the second variables (yᵢ) based on the first variables (xᵢ).

For example, during the updating operation

performed for each unit time, for each of a plurality of elements, the updating unit 14 updates the first variables (xᵢ) before updating the second variables (yᵢ). Alternatively, during the updating operation for each time, for each of a plurality of elements, the updating unit 14 can update the second variables (yᵢ) before updating the first variables (xᵢ).

Moreover, during the updating operation performed for each unit time, after updating the second variables (yᵢ), the updating unit 14 performs constraint processing so as to ensure that the solution of the 0-1 combinatorial optimization problem satisfies one or more constraint conditions. For each of one or more constraint conditions, if the inequality expression in which the first variable (xᵢ) corresponding to each of a plurality of discrete variables is substituted is not satisfied, then the updating unit 14 subtracts a correction value (r_{m, i}), which corresponds to the components of the elements present within the distance from the boundary of the corresponding inequality expression to the positions identified by a plurality of elements, from the second variable (yᵢ) of each of a plurality of elements.

During the updating operation performed for each unit time, as a result of performing constraint processing for each of one or more constraint conditions, if a plurality of first variables (xᵢ) does not satisfy the constraint condition, the updating unit 14 can correct a plurality of second variables (yᵢ), which corresponds to a plurality of elements, in such a way that a plurality of first variables (xᵢ) changes toward satisfying the constraint condition. As a result, the updating unit 14 becomes able to increase the probability of a plurality of first variables (xᵢ) satisfying all of one or more constraint conditions at the end timing (t=T).

Meanwhile, during the updating operation performed for each unit time, in the case of updating the first variables (xᵢ) before updating the second variables (yᵢ), for each of a plurality of elements, the updating unit 14 updates the second variables (yᵢ) before subtracting the correction value (r_{m, i}) from the second variables (yᵢ). Alternatively, during the updating operation performed for each unit time, in the case of updating the second variables (yᵢ) before updating the first variables (xᵢ), for each of a plurality of elements, the updating unit 14 updates the second variables (yᵢ) and, before updating the first variables (xᵢ), subtracts the correction value (r_{m, i}) from the second variables (yᵢ).

### Operation Flow

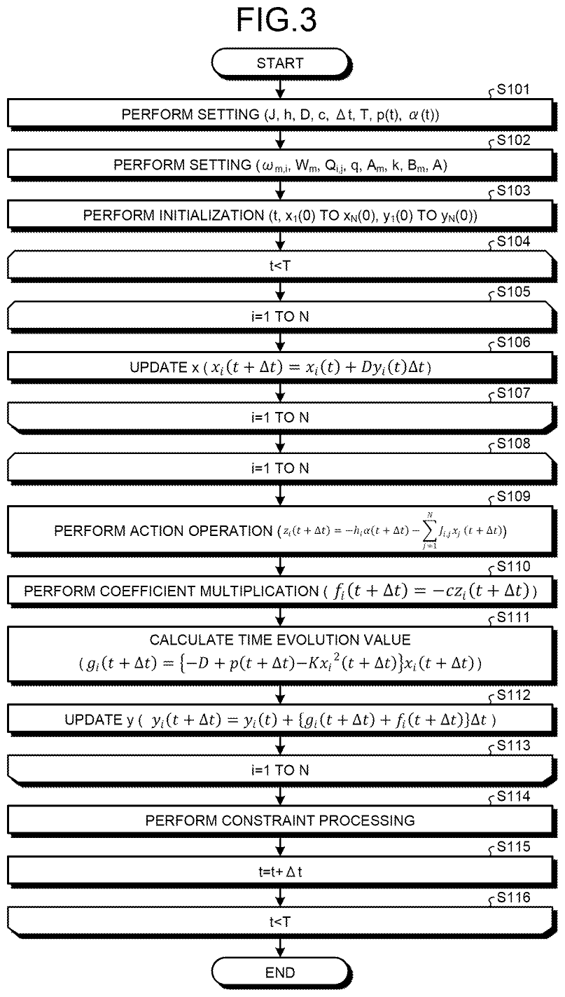

FIG. 3 is a flowchart for explaining a first example of the flow of operations performed by the updating unit 14. Thus, the updating unit 14 performs operations according to, for example, the flow illustrated in FIG. 3.

Firstly, at S101, the updating unit 14 sets parameters for solving a 0-1 combinatorial optimization problem. More particularly, the updating unit 14 sets the matrix J that includes N×N number of coupling coefficients, and sets the array h that includes local magnetic coefficients representing N number of local magnetic fields. Moreover, the updating unit 14 sets the coefficient D, the coefficient c, the unit time Δt, the end timing (T), the function p(t), and the function α(t). The functions p(t) and α(t) are increasing functions that take the value “0” at t=initial timing (for example, the timing 0) and take the value “1” at t=end timing (T). The updating unit 14 sets the matrix J and the array h according to the information received from the input unit 12. The updating unit 14 either can set D, c, Δt, T, p(t), and α(t) according to the value received from the input unit 12, or can set those values to pre-decided and non-variable values.

Then, at S102, the updating unit 14 sets the information related to the constraint conditions. More particularly, the updating unit 14 sets the information to be used in defining one or more constraint conditions and sets the information indicating the coefficients required in performing constraint processing. For example, when a constraint condition is expressed using a linear inequality expression, the updating unit 14 sets the coefficient om, that is to be multiplied to variables; sets the constant term (Wₘ); sets the coefficient Aₘ (or the coefficients Aₘ and Bₘ) required in performing constraint processing; and sets the integer k. Alternatively, for example, when a constraint condition is expressed using a quadratic inequality expression, the updating unit 14 sets the coefficient Q_{i,j} that is multiplied to variables; sets the constant term (q); and sets the coefficient A and the integer k required in performing constraint processing. Herein, the updating unit 14 can update the coefficients Aₘ, Bₘ, k, and A, which are required in performing constraint processing, according to the parameters received from the input unit 12, or can set those coefficients to pre-decided and non-variable values.

Subsequently, at S103, the updating unit 14 initializes the variables. More particularly, the updating unit 14 initializes the variable t, which indicates the timing, to the initial timing (for example, “0”). Moreover, to each of the N number of first variables (x₁(t) to x_{N}(t)) and each of the N number of second variables (y₁(t) to y_{N}(t)), the updating unit 14 either assigns an initial value received from the user, or assigns a predetermined fixed value, or assigns a random number.

Then, the updating unit 14 repeatedly performs a loop operation between S104 and S116 till the timing t exceeds the end timing T. In a single iteration of the loop operation, the updating unit 14 calculates the N number of first variables (x₁(t+Δt) to x_{N}(t+Δt)) at the target timing (t+Δt) based on the N number of first variables (x₁(t) to x_{N}(t)) at the immediately previous timing (t) and based on the N number of second variables (y₁(t) to y_{N}(t)) at the immediately previous timing (t). Moreover, in a single iteration of the loop operation, the updating unit 14 calculates the N number of second variables (y₁(t+Δt) to y_{N}(t+Δt)) at the target timing (t+Δt) based on the N number of first variables (x₁(t+Δt) to x_{N}(t+Δt)) at the target timing (t+Δt) and based on the N number of second variables (y₁(t) to y_{N}(t)) at the immediately previous timing (t).

Herein, the immediately previous timing (t) represents the timing earlier than the target timing (t+Δt) by the amount of time equal to the unit time (Δt). Thus, as a result of repeatedly performing the loop operation between S104 and S116, the updating unit 14 sequentially updates, for each unit time Δt from the initial timing (t=0) to the end timing (t=T), the N number of first variables (x₁(t) to x_{N}(t)) and the N number of second variables (y₁(t) to y_{N}(t)).

Subsequently, the updating unit 14 repeatedly performs a loop operation between S105 and S107 while incrementing the index i by one from 1 to N. Herein, “i” represents an integer taking a value from 1 to N, and represents the index for indicating the target element for processing from among the N number of elements. Each of the N number of elements is associated with the first variable (xᵢ(t)) and the second variable (yᵢ(t)). Thus, in the loop operation between S105 and S107, the updating unit 14 performs the operations with respect to the i-th element representing the target element from among the N number of elements.

At S106, the updating unit 14 calculates the first variable (xᵢ(t+Δt)) at the target timing (t+Δt) for the target element by adding, to the first variable (xᵢ(t)) at the immediately previous timing (t) for the target element, a value obtained by the multiplication of the second variable (yᵢ(t)) at the immediately previous timing (t) for the target element, the predetermined constant number D, and the unit time (Δt). More particularly, the updating unit 14 calculates Formula (23) given below.

xᵢ(t+Δt)=xᵢ(t)+Dyᵢ(t)Δt (23)

That is, for each of the N number of elements, the updating unit 14 updates the first variable (xi(t+Δt)) at the target timing (t+Δt) for the target element based on the first variable (xᵢ(t)) at the immediately previous timing (t) for the target element and based on the second variable (yᵢ(t)) at the immediately previous timing (t) for the target element.

After the updating unit 14 has performed the loop operation between S105 and S107 for N number of times, the system control proceeds to S108.

Subsequently, the updating unit 14 repeatedly performs the loop operation between S108 and S113 while incrementing the index i by one from 1 to N.

At S109, the updating unit 14 calculates an updated value (zᵢ(t+Δt)) based on the first variables (x₁(t+Δt) to x_{N}(t+Δt)) at the target timing (t+Δt) for each of the N number of elements and based on action coefficients predetermined according to the 0-1 combinatorial optimization problem for each pair of the target element and each of the N number of elements. The action coefficients include the coupling coefficient included in the matrix J and the local magnetic field coefficient included in the array h. More particularly, the updating unit 14 performs an action operation by calculating Formula (24) given below.

$${z}_{i} ( t + Δ t ) = - {h}_{i} α ( t + Δ t ) - {\sum }_{i = 1}^{N} {J}_{i , j} {x}_{j} ( t + Δ t ) \qquad ( 24 )$$

Then, at S110, the updating unit 14 multiplies the coefficient c and “−1” to the updated value zᵢ(t+Δt), and calculates an external force fᵢ(t+Δt). More particularly, the updating unit 14 calculates Formula (25) given below.

fᵢ(t+Δt)=−czᵢ(t+Δt) (25)

Subsequently, at S111, the updating unit 14

multiplies the first variable (x₁(t+Δt)) at the target timing (t+Δt) for the target element to the value decided based on the increasing function p(t+Δt) that increases over time, and calculates a time evolution value (gᵢ(t+Δt)). More particularly, the updating unit 14 calculates Formula (26) given below.

gᵢ(t+Δt)={−D+p(t+Δt)−kxᵢ²(t+Δt)}xᵢ(t+Δt) (26)

Then, at S112, the updating unit 14 adds, to the second variable (yᵢ(t)) at the immediately previous timing (t) for the target element, the value obtained by multiplying the unit time (Δt) and the value to which the time evolution value (gᵢ(t+Δt)) and the external force fᵢ(t+Δt) are added; and calculates the second variable (yᵢ(t+Δt)) at the target timing (t+Δt) for the target element. More particularly, the updating unit 14 calculates Formula (27) given below.

yᵢ(t+Δt)=yᵢ(t)+{gᵢ(t+Δt)+fᵢ(t+Δt)}Δt (27)

The updating unit 14 performs the loop operation between S108 and S113 for N number of times and, for each of the N number of elements, updates the second variable (yᵢ(t+Δt)) at the target timing (t+Δt) based on the N number of first variables (x₁(t+Δt) to x_{N}(t+Δt)) at the target timing (t+Δt) and based on the second variable (yᵢ(t)) at the immediately previous timing (t) for the target element.

After the updating unit 14 has performed the loop operation between S108 and S113 for N number of times, the system control proceeds to S114.

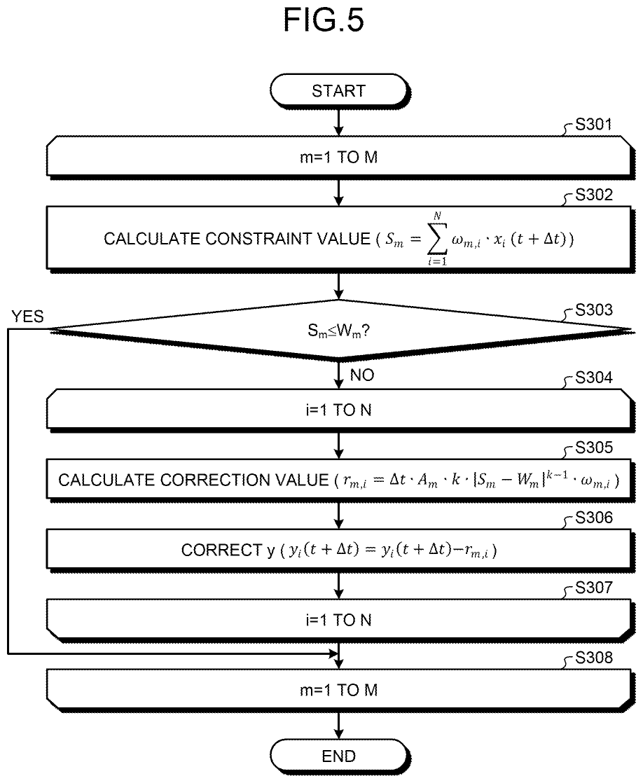

At S114, the updating unit 14 performs constraint processing based on one or more constraint conditions. Regarding the constraint processing, the detailed explanation is given later with reference to flowcharts illustrated in FIGS. 5 to 7. After the updating unit 14 has performed the operation at S114, the system control proceeds to S115.

At S115, the updating unit 14 adds the unit time (Δt) to the immediately previous timing (t) and the target timing (t+Δt), and thus updates the immediately previous timing (t) and the target timing (t+Δt). At S116, the updating unit 14 performs the operations from S105 to S115 till the timing t exceeds the end timing T. Once the timing t exceeds the end timing T, the updating unit 14 ends the present flow of operations.

Then, for each of the N number of elements, according to the sign of the first variable (xᵢ(T)) at the end timing (t=T), the output unit 16 calculates the value of the corresponding spin. For example, if the first variable (xᵢ(T)) at the end timing (t=T) has the negative sign, then the output unit 16 sets the corresponding spin to “−1”. On the other hand, if the first variable (xᵢ(T)) at the end timing (t=T) has the positive sign, then the output unit 16 sets the corresponding spin to “+1”. Subsequently, the output unit 16 outputs, as the solution of the combinatorial optimization problem, either the calculated values of a plurality of spins or the values obtained by converting the calculated values of a plurality of spins into discrete variables.

As a result of performing the operations from S101 to S116, the updating unit 14 becomes able to perform the computation according to the enhanced algorithm and calculate the N number of first variables (x₁(t) to x_{N}(t)) and the N number of second variables (y₁(t) to y_{N}(t)) at the end timing (t=T).

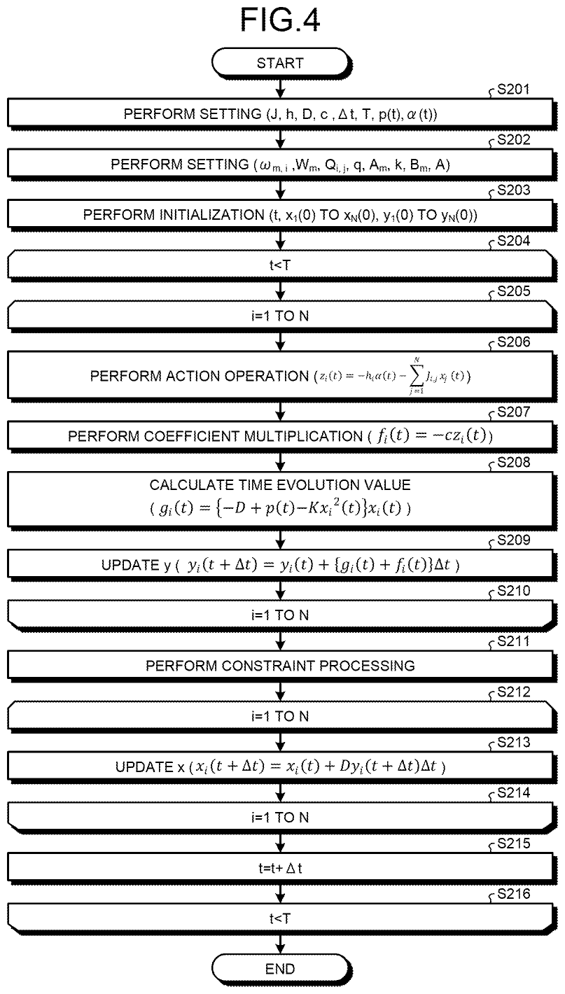

FIG. 4 is a flowchart for explaining a second example of the flow of operations performed by the updating unit 14. Thus, in the case of solving a 0-1 combinatorial optimization problem according to the enhanced algorithm, the updating unit 14 can perform the operations according to the flow illustrated in FIG. 4 instead of the flow illustrated in FIG. 3.

Firstly, at S201, S202, and S203, the updating unit performs the operations identical to the operations performed at S101, S102, and S103, respectively, illustrated in FIG. 3 according to the first example.

Then, the updating unit 14 repeatedly performs a loop operation between S204 and S216 till the timing t exceeds the end timing T. In a single iteration of the loop operation, the updating unit 14 calculates the N number of second variables (y₁(t+Δt) to y_{N}(t+Δt)) at the target timing (t+Δt) based on the N number of first variables (x₁(t) to x_{N}(t)) at the immediately previous timing (t) and based on the N number of second variables (y₁(t) to y_{N}(t)) at the immediately previous timing (t). Moreover, in a single iteration of the loop operation, the updating unit 14 calculates the N number of first variables (x₁(t+Δt) to x_{N}(t+Δt)) at the target timing (t+Δt) based on the N number of first variables (x₁(t) to x_{N}(t)) at the immediately previous timing (t) and based on the N number of second variables (y₁(t+Δt) to y_{N}(t+Δt)) at the target timing (t+Δt).

Subsequently, the updating unit 14 repeatedly performs a loop operation between S205 and S210 while incrementing the index i by one from 1 to N. Thus, in the loop operation between S205 and S210, the updating unit 14 performs the operations with respect to the i-th element representing the target element from among the N number of elements.

At S206, the updating unit 14 calculates an updated value zᵢ(t) based on the first variables (x₁(t) to x_{N}(t)) at the immediately previous timing (t) for each of the N number of elements and based on action coefficients predetermined according to the 0-1 combinatorial optimization problem for each pair of the target element and each of the N number of elements. More particularly, the updating unit 14 calculates Formula (28) given below.

$${z}_{i} ( t ) = - {h}_{i} α ( t ) - {\sum }_{j = 1}^{N} {J}_{i , j} {x}_{j} ( t ) \qquad ( 28 )$$

Then, at S207, the updating unit 14 multiplies the coefficient c and “−1” to the updated value zᵢ(t), and calculates an external force fᵢ(t). More particularly, the updating unit 14 calculates Formula (29) given below.

fᵢ(t)=−czᵢ(t) (29)

Subsequently, at S208, the updating unit 14 multiplies the first variable (x₁(t)) at the immediately previous timing (t) for the target element to the value decided based on the increasing function p(t+Δt) that increases over time, and calculates the time evolution value (gᵢ(t)). More particularly, the updating unit 14 calculates Formula (30) given below.

gᵢ(t)={−D+p(t)−Kxᵢ²(t)}xᵢ(t) (30)

Then, at S209, the updating unit 14 adds, to the second variable (yᵢ(t)) at the immediately previous timing (t) for the target element, the value obtained by multiplying the unit time (Δt) and the value to which the time evolution value (gᵢ(t)) and the external force fᵢ(t) are added; and calculates the second variable (yᵢ(t+Δt)) at the target timing (t+Δt) for the target element. More particularly, the updating unit 14 calculates Formula (31) given below.

yᵢ(t+Δt)=yᵢ(t)+{gᵢ(t)+fᵢ(t)}Δt (31)

The updating unit 14 performs the loop operation between S205 and S210 as explained above for N number of times and, for each of the N number of elements, updates the second variable (yᵢ(t+Δt)) at the target timing (t+Δt) based on the N number of first variables (x₁(t) to x_{N}(t)) at the immediately previous timing (t) for the target element and based on the N number of second variables (y₁(t) to y_{N}(t)) at the immediately previous timing (t) for the target element.

After the updating unit 14 has performed the loop operation between S205 and S210 for N number of times, the system control proceeds to S211.

At S211, the updating unit 14 performs constraint processing based on one or more constraint conditions. Regarding the constraint processing, the detailed explanation is given later with reference to flowcharts illustrated in FIGS. 5 to 7. After the updating unit 14 has performed the operation at S211, the system control proceeds to S212.

Subsequently, the updating unit 14 repeatedly performs the loop operation between S212 and S214 while incrementing the index i by one from 1 to N.

At S213, the updating unit 14 adds, to the first variable (xᵢ(t)) at the immediately previous timing (t) for the target element, the value obtained by multiplying the second variable (yᵢ(t+Δt)) at the target timing (t+Δt) for the target element, the predetermined constant number D, and the unit time (Δt); and calculates the first variable (xᵢ(t+Δt)) at the target timing (t+Δt) for the target element. More particularly, the updating unit 14 calculates Formula (32) given below.

xᵢ(t+Δt)=xᵢ(t)+Dyᵢ(t+Δt)Δt (32)

That is, for each of the N number of elements, the updating unit 14 updates the first variable (xᵢ(t+Δt)) at the target timing (t+Δt) for the target element based on the first variable (xᵢ(t)) at the immediately previous timing (t) for the target element and based on the second variable (yᵢ(t)) at the immediately previous timing (t) for the target element.

After the updating unit 14 has performed the loop operation between S212 and S214 for N number of times, the system control proceeds to S215.

At S215, the updating unit 14 adds the unit time (Δt) to the immediately previous timing (t) and the target timing (t+Δt), and thus updates the immediately previous timing (t) and the target timing (t+Δt). At S216, the updating unit 14 performs the operations from S212 to S215 till the timing t exceeds the end timing (T). Once the timing t exceeds the end timing (T), the updating unit 14 ends the present flow of operations.

Then, for each of the N number of elements, according to the sign of the first variable (xᵢ(T)) at the end timing (t=T), the output unit 16 calculates the value of the corresponding spin. For example, if the first variable (xᵢ(T)) at the end timing (t=T) has the negative sign, then the output unit 16 sets the corresponding spin to “−1”. On the other hand, if the first variable (xᵢ(T)) at the end timing (t=T) has the positive sign, then the output unit 16 sets the corresponding spin to “+1”. Subsequently, the output unit 16 outputs, as the solution of the combinatorial optimization problem, either the calculated values of a plurality of spins or the values obtained by converting the calculated values of a plurality of spins into discrete variables.

As a result of performing the operations from S201 to S216, the updating unit 14 becomes able to perform the computation according to the enhanced algorithm and calculate the N number of first variables (x₁(t) to x_{N}(t)) and the N number of second variables (y₁(t) to y_{N}(t)) at the end timing (t=T).

### First Example of Constraint Processing

FIG. 5 is a flowchart for explaining a first example of the flow of operations performed during constraint processing. When M number of linear inequality expressions are set as one or more constraint conditions, the updating unit 14 performs, at S114 illustrated in FIG. 3 and at S211 illustrated in FIG. 4, the operations according to the flow illustrated in FIG. 5.

Firstly, the updating unit 14 repeatedly performs a loop operation between S301 and S308 while incrementing an index m by one from m=1 to m=M. Herein, “m” represents the index for indicating the target linear inequality expression for processing from among the M number of linear inequality expressions.

In the loop operation between S301 and S308, firstly, at S302, the updating unit 14 calculates the constraint value Sₘ. More particularly, in the constraint processing performed at S114 illustrated in FIG. 3, the updating unit 14 performs the computation as given below in Formula (33). Moreover, in the constraint processing performed at S211 illustrated in FIG. 5, the updating unit 14 performs the computation as given below in Formula (34).

$${S}_{m} = {\sum }_{i = 1}^{N} {ω}_{m , i} \cdot {x}_{i} ( t + Δ t ) \qquad ( 33 )$$

$${S}_{m} = {\sum }_{i = 1}^{N} {ω}_{m , i} \cdot {x}_{i} ( t ) \qquad ( 34 )$$

Meanwhile, Sₘ as the constraint value is obtained when, in each of a plurality of discreet variables included in the functions excluding the constant term (Wₘ) in the corresponding linear inequality expression, the corresponding first variable (xᵢ) is substituted.

Subsequently, at S303, the updating unit 14 determines whether or not the constraint value Sₘ is equal to or smaller than the constant term (Wₘ) in the corresponding linear inequality expression. That is, the updating unit 14 determines whether or not a plurality of first variables (xᵢ) satisfies the corresponding linear inequality expression.

If the constraint value Sm is equal to or smaller than the constant term (Wₘ) in the corresponding linear inequality expression, that is, if a plurality of first variables (xᵢ) satisfies the corresponding linear inequality expression (Yes at S303), then the system control proceeds to S308. On the other hand, if the constraint value (Sₘ) is neither equal to nor smaller than the constant term (Wₘ) in the corresponding linear inequality expression, that is, if a plurality of first variables (xᵢ) does not satisfy the corresponding linear inequality expression (No at S303), then the system control proceeds to S304.

Then, the updating unit 14 repeatedly performs the loop operation between S304 and S307 while incrementing the index i by one from 1 to N. In the loop operation performed between S304 and S307, the updating unit 14 performs the operations with respect to the i-th element representing the target element from among the N number of elements.

In the loop operation between S304 and S307, firstly, at S305, the updating unit 14 calculates the correction value (r_{m ,i}) that corresponds to the component of the target element present within the distance from the boundary of the corresponding inequality expression to the positions identified by a plurality of elements. More particularly, the updating unit 14 performs the computation as given below in Formula (35).

r_{m,i}=Δt·Aₘ·k·|sₘ−Wₘ|^{k-1}·ω_{m,i} (35)

Subsequently, at S306, the updating unit 14 corrects y by subtracting the correction value (r_{m, i}) from the second variable (yᵢ) of the target element. More particularly, the updating unit 14 performs the computation as given below in Formula (36).

yᵢ(t+Δt)=yᵢ(t+Δt)−r_{m,i} (36)

After the updating unit 14 has performed the loop operation between S304 and S307, the system control proceeds to S308.

Then, after the updating unit 14 has performed the loop operation between S301 and S308 for M number of times, that is, when the operations have been performed for all of the M number of linear inequality expressions, the updating unit 14 ends the present flow of operations.

As a result of performing the operations explained above, for each of the M number of inequality expressions, if a plurality of first variables (xᵢ) does not satisfy the concerned linear inequality expression; then the updating unit 14 becomes able to subtract, from the second variable (yᵢ) of each of a plurality of elements, the correction value (r_{m, i}) that corresponds to the component of the target element present within the distance from the boundary of the corresponding inequality expression to the positions identified by a plurality of elements. As a result, when a plurality of first variables (xᵢ) does not satisfy the corresponding linear inequality expression, the updating unit 14 can correct a plurality of second variables (yᵢ) in such a way that a plurality of first variables (xᵢ) changes toward satisfying the corresponding inequality expression. As a result, the updating unit 14 becomes able to increase the probability of a plurality of first variables (xᵢ) satisfying all of one or more constraint conditions at the end timing (t=T).

### Second Example of Constraint Processing

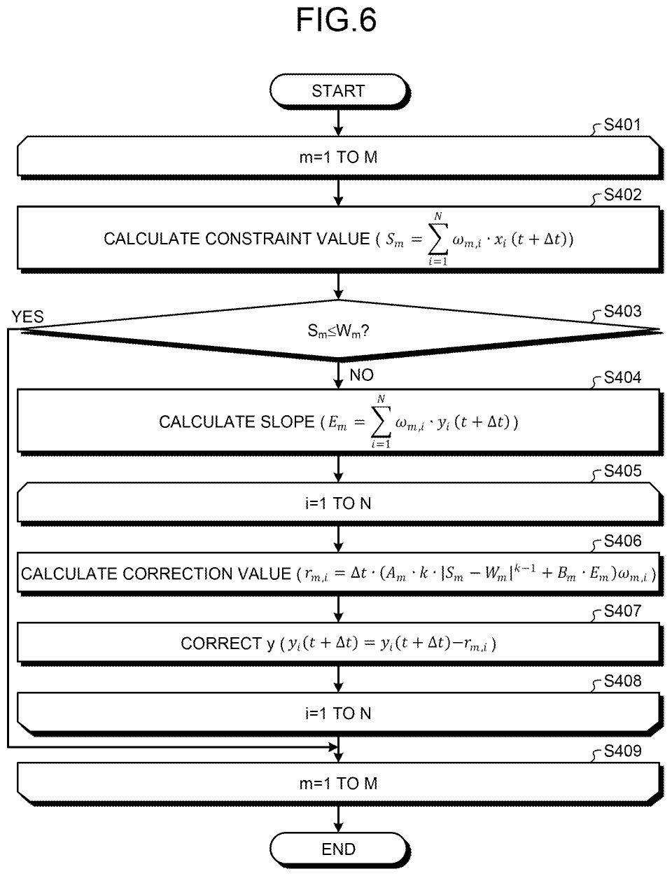

FIG. 6 is a flowchart for explaining a second example of the flow of operations performed during constraint processing. When M number of linear inequality expressions are set as one or more constraint conditions, the updating unit 14 performs, at S114 illustrated in FIG. 3 and at S211 illustrated in FIG. 4, the operations according to the flow illustrated in FIG. 6.

Firstly, the updating unit 14 repeatedly performs a loop operation between S401 and S409 while incrementing the index m by one from m=1 to m=M.

In the loop operation between S401 and S409,

firstly, at S402, the updating unit 14 calculates the constraint value (Sₘ). The operation performed at S402 is identical to the operation performed at S302 illustrated in FIG. 5.

Then, at S403, the updating unit 14 determines whether or not the constraint value (Sₘ) is equal to or smaller than the constant term (Wₘ) in the corresponding linear inequality expression. The operation performed at S403 is identical to the operation performed at S303 illustrated in FIG. 5. If the constraint value Sₘ is equal to or smaller than the constant term (Wₘ) in the corresponding linear inequality expression (Yes at S403), then the system control proceeds to S409. On the other hand, if the constraint value Sₘ is neither equal to nor smaller than the constant term (Wₘ) in the corresponding linear inequality expression (No at S403), then the system control proceeds to S404.

At S404, the updating unit 14 calculates the slope Eₘ with respect to the boundary of the corresponding linear inequality expression in the direction identified by a plurality of elements. More particularly, the updating unit 14 performs the computation as given below in Formula (37).

$${E}_{m} = {\sum }_{i = 1}^{N} {ω}_{m , i} \cdot {y}_{i} ( t + Δ t ) \qquad ( 37 )$$

Subsequently, the updating unit 14 repeatedly performs a loop operation between S405 and S408 while incrementing the index i by one from 1 to N. Thus, in the loop operation between S405 and S408, the updating unit 14 performs the operations with respect to the i-th element representing the target element from among the N number of elements.

In the loop operation between S405 and S408, firstly, at S406, the updating unit 14 calculates the correction value (r_{m, i}) that corresponds to the component of the target element present within the distance from the boundary of the linear inequality expression to the positions identified by a plurality of elements and that corresponds to the component of the target element having a slope with respect to the boundary of the linear inequality expression in the direction identified by a plurality of elements. More particularly, the updating unit 14 performs the computation as given below in Formula (38).

r_{m,i}=Δt·(Aₘ·k·|Sₘ−Wₘ|^{k-1}+Bₘ·Eₘ)ω_{m,i} (38)

Then, at S407, the updating unit 14 corrects y by subtracting the correction value (r_{m, i}) from the second variable (yᵢ) of the target element. The operation performed at S407 is identical to the operation performed at S306.

After the updating unit 14 has performed the loop operation between S405 and S408 for N number of times, the system control proceeds to S409.

Then, after the updating unit 14 has performed the loop operation between S401 and S409 for M number of times, that is, when the operations have been performed for all of the M number of linear inequality expressions, the updating unit 14 ends the present flow of operations.

As a result of performing the operations explained above, for each of the M number of linear inequality expressions, if a plurality of first variables (xᵢ) does not satisfy the corresponding linear inequality expression, the updating unit 14 becomes able to subtract, from the second variables (yᵢ) of each of a plurality of elements, the correction value (r_{m, i}) that corresponds to the component of the target element present within the distance from the boundary of the linear inequality expression to the positions identified by a plurality of elements and that corresponds to the component of the target element having a slope with respect to the boundary of the linear inequality expression in the direction identified by a plurality of elements. Particularly, as a result of adding, to the correction value (r_{m, i}), the value corresponding to the component of the target element having a slope with respect to the boundary of the linear inequality expression in the direction identified by a plurality of elements; the updating unit 14 becomes able to hold down unstable fluctuation of a plurality of first variables (xᵢ) and a plurality of second variables (yᵢ) during the updating operation performed for each unit time (Δt).

Thus, when a plurality of first variables (xᵢ) does not satisfy the corresponding linear inequality expression, the updating unit 14 becomes able to correct a plurality of second variables (yᵢ), which corresponds to a plurality of elements, in such a way that a plurality of first variables (xᵢ) stably changes toward satisfying the corresponding linear inequality expression. As a result, the updating unit 14 becomes able to increase the probability of a plurality of first variables (xᵢ) satisfying all of one or more constraint conditions at the end timing (t=T).

### Third Example of Constraint Processing

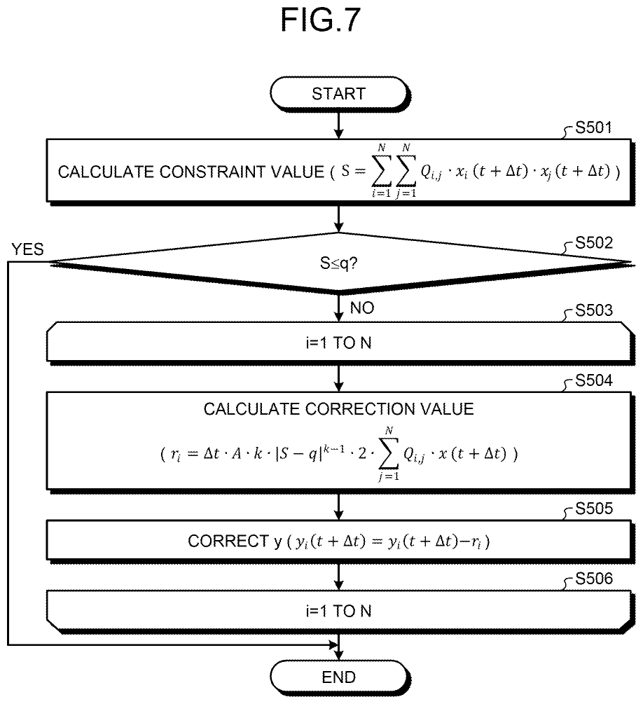

FIG. 7 is a flowchart for explaining a third example of the flow of operations performed during constraint processing. From among one or more constraint conditions, when one constraint condition has a quadratic inequality expression set therein, regarding the quadratic inequality expression, the updating unit 14 performs the operations from S501 to S506 illustrated in FIG. 7 instead of either performing the operations from S302 to S307 illustrated in FIG. 5 or performing the operations from S402 to S408 illustrated in FIG. 6.

Firstly, at S501, the updating unit 14 calculates the constraint value S. More particularly, in the constraint processing performed at S114 illustrated in FIG. 3, the updating unit 14 performs the computation as given below in Formula (39). Moreover, in the constraint processing performed at S211 illustrated in FIG. 4, the updating unit 14 performs the computation as given below in Formula (40).

$$S = {\sum }_{i = 1}^{N} {\sum }_{j = 1}^{N} {Q}_{i , j} \cdot {x}_{i} ( t + Δ t ) \cdot {x}_{j} ( t + Δ t ) \qquad ( 39 )$$

$$S = {\sum }_{i = 1}^{N} {\sum }_{j = 1}^{N} {Q}_{i , j} \cdot {x}_{i} ( t ) \cdot {x}_{j} ( t ) \qquad ( 40 )$$

Meanwhile, S as the constraint value is obtained when, in each of a plurality of discreet variables included in the functions excluding the constant term (q) in the corresponding quadratic inequality expression, the corresponding first variable (xᵢ) is substituted.

Then, at S502, the updating unit 14 determines whether or not the constraint value (S) is equal to or smaller than the constant term (q) in the quadratic inequality expression. That is, the updating unit 14 determines whether or not a plurality of first variables (xᵢ) satisfies the quadratic inequality expression.

When the constraint value (S) is equal to or smaller than the constant term (q), that is, when a plurality of first variables (xᵢ) satisfies the corresponding quadratic inequality expression (Yes at S502), the updating unit 14 ends the present flow of operations. On the other hand, when the constraint value (S) is neither equal to nor smaller than the constant term (q), that is, when a plurality of first variables (xᵢ) does not satisfy the corresponding quadratic inequality expression (No at S502), the system control proceeds to S503.

Subsequently, the updating unit 14 repeatedly performs a loop operation between S503 and S506 while incrementing the index i by one from 1 to N. Thus, in the loop operation between S503 and S506, the updating unit 14 performs the operations with respect to the i-th element representing the target element from among the N number of elements.

In the loop operation between S503 and S506, firstly, at S504, the updating unit 14 calculates a correction value (rᵢ) that corresponds to the component of the target element present within the distance from the boundary of the quadratic inequality expression to the positions identified by a plurality of elements. More particularly, in the constraint processing performed at S114 illustrated in FIG. 3, the updating unit 14 performs the computation as given below in Formula (41). Moreover, in the constraint processing performed at S211 illustrated in FIG. 4, the updating unit 14 performs the computation as given below in Formula (42).

$${r}_{i} = Δ t \cdot A \cdot k \cdot {\vert S - q \vert}^{k - 1} \cdot 2 \cdot {\sum }_{j = 1}^{N} {Q}_{i , j} \cdot x ( t + Δ t ) \qquad ( 41 )$$

$${r}_{i} = Δ t \cdot A \cdot k \cdot {\vert S - q \vert}^{k - 1} \cdot 2 \cdot {\sum }_{j = 1}^{N} {Q}_{i , j} \cdot x ( t ) \qquad ( 42 )$$

Subsequently, at S505, the updating unit 14 corrects y by subtracting the correction value (rᵢ) from the second variable (yᵢ) of the target element. More particularly, the updating unit 14 performs the computation as given below in Formula (43).

yᵢ(t+Δt)=yᵢ(t+Δt)−rᵢ (43)

After performing the loop operation between S503 and S506 for N number of times, the updating unit 14 ends the present flow of operations.

As a result of performing the operations explained above, regarding quadratic inequality expressions, when a plurality of first variables (xᵢ) does not satisfy the corresponding quadratic inequality expression, the updating unit 14 can subtract, from the second variable (yᵢ) of each of a plurality of elements, the correction value (rᵢ) that corresponds to the component of the target element present within the distance from the boundary of the concerned quadratic inequality expression to the positions identified by a plurality of elements. As a result, when a plurality of first variables (xᵢ) does not satisfy the corresponding quadratic inequality expression, the updating unit 14 can correct a plurality of second variables (yᵢ) in such a way that a plurality of first variables (xᵢ) changes toward satisfying the corresponding quadratic inequality expression. As a result, the updating unit 14 becomes able to increase the probability of a plurality of first variables (xᵢ) satisfying all of one or more constraint conditions at the end timing (t=T).

As explained above, in the solution finding device 10 according to the present embodiment, the 0-1 combinatorial optimization problem is solved according to a simulated bifurcation algorithm. In the solution finding device 10 according to the present embodiment, during the updating operation performed for each unit time (Δt), for each of one or more constraint conditions, when an inequality expression in which first variables corresponding to a plurality of discrete variables are substituted is not satisfied, the correction value (rᵢ) that corresponds to the component of the target element present within the distance from the boundary of the inequality expression to the positions identified by a plurality of elements is subtracted from the second variable (yᵢ) of each of a plurality of elements.

Hence, in the solution finding device 10 according to the present embodiment, under one or more constraint conditions expressed using inequality expressions, even if a 0-1 combinatorial optimization problem is to be solved, the solution can be obtained using the same number of variables as the number of variables in the case of not setting any constraint condition. Thus, in the solution finding device 10 according to the present embodiment, a 0-1 combinatorial optimization problem can be easily solved under one or more constraint conditions, which are expressed using inequality expressions, without having to set slack variables. As a result, in the solution finding device 10 according to the present embodiment, it becomes possible to reduce the amount of memory used for storing the intermediate progress of the variables, and to reduce the amount of computation and the time of computation.

Meanwhile, in the case of performing constraint processing with respect to a linear inequality expression, M number of first-type inequality expressions can be generated and the coefficient ω_{m, i}, which is multiplied to the i-th discrete variable, and the constant number (Wₘ) of inequality expressions can be called.

$${\sum }_{m = 1}^{M} ( {ω}_{m , i} , - {W}_{m} ) ( \begin{matrix}{x}_{i} \\ 1\end{matrix} ) ≦ 0 \qquad ( 44 )$$

In the solution finding device 10, when the column number and the row number are specified once, the coefficient ω_{m, i} and the constant number (Wₘ) can be read simultaneously, and the processing can be performed with ease.

### System Configuration

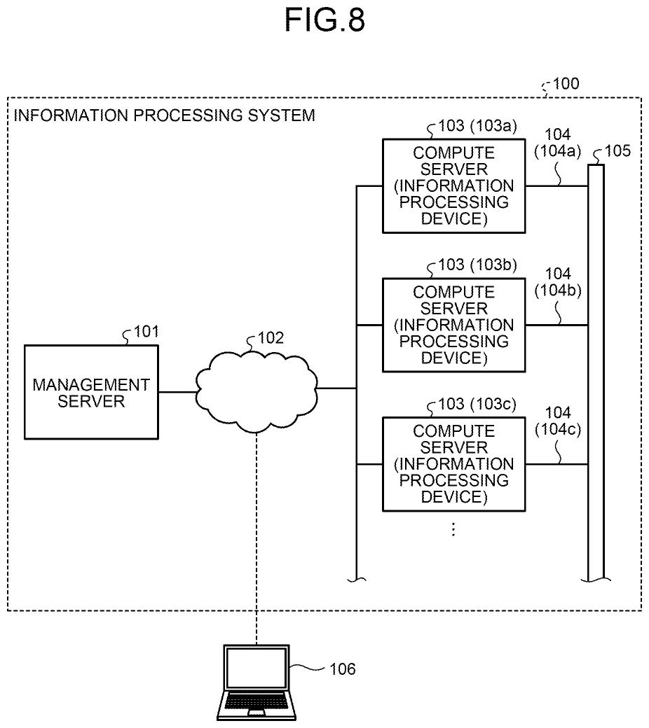

FIG. 8 is a diagram illustrating a configuration of an information processing system 100. The enhanced algorithm can be executed in, for example, the information processing system 100 illustrated in FIG. 8. As a result, in the information processing system 100, a large-scale combinatorial optimization problem can be solved at a fast rate by performing parallel processing.

The information processing system 100 includes a management server 101, a network 102, a plurality of compute servers 103 (103a to 103c) (information processing devices), a plurality of cables 104 (104a to 104c), and a switch 105. Meanwhile, a terminal device 106 is provided that is capable of communicating with the information processing system 100. The management server 101, the compute servers 103 (103a to 103c), and the terminal device 106 perform data communication with each other via a network 102. The network 102 is, for example, the Internet in which a plurality of computer networks is connected to each other. As far as the communication medium is concerned, the network 102 can be a wired network, a wireless network, or a combination thereof.

The compute servers 103 (103a to 103c) are connected to the switch 105 via the cables 104 (104a to 104c). The cables 104 (104a to 104c) and the switch 105 constitute the interconnects among the compute servers 103. Thus, the compute servers (103a to 103c) are capable of performing data communication also with each other via the interconnects. The switch 105 is, for example, an InfiniBand switch. The cables 104a to 104c are, for example, InfiniBand cables. Alternatively, the switch 105 and the cables 104 can be a wired LAN switch and wired LAN cables, respectively. Meanwhile, regarding the communication standard and the communication protocol implemented in the cables 104 and the switch 105, there is no particular restriction. The terminal device 106 is, for example, a notebook PC, a desktop PC, a smartphone, a tablet, or an in-vehicle terminal device.

Regarding a combinatorial optimization problem, the solution finding operation using the enhanced algorithm can be performed in a parallel manner or a dispersive manner. Thus, the compute servers 103 (103a to 103a) and/or the processors thereof either can be instructed to execute some steps of some part of the computation in the solution finding operation performed with respect to a combinatorial optimization problem based on the enhanced algorithm, or can perform the same computation in parallel with respect to difference variables. In that case, for example, the management server 101 converts the combinatorial optimization problem, which is input by the user, into a format processible by the compute servers 103, and causes the compute servers 103 to perform the processing. Then, the management server 101 obtains the computation results from the compute servers 103, and converts the collected computation results into the solution of the combinatorial optimization problem.

In FIG. 8, three compute servers 103 (103a to 103c) are illustrated. However, in the information processing system 100, the number of compute servers 103 is not limited to three. For example, only a single information processing system 100 can be provided, or two information processing systems 100 can be provided, or four or more information processing systems 100 can be provided. Meanwhile, in the information processing system 100, the solution finding operation for a combinatorial optimization problem can be performed using some of a plurality of compute servers 103. Herein, the compute servers 103 can be any type of information processing devices. For example, the compute servers 103 can be servers installed in a data center, or can be desktop PCs installed in an office. Alternatively, the compute servers 103 can be a plurality of types of computers installed at different locations. Moreover, for example, the compute servers 103 can be general-purpose computers, or can be dedicated electronic circuits, or can be a combination thereof.

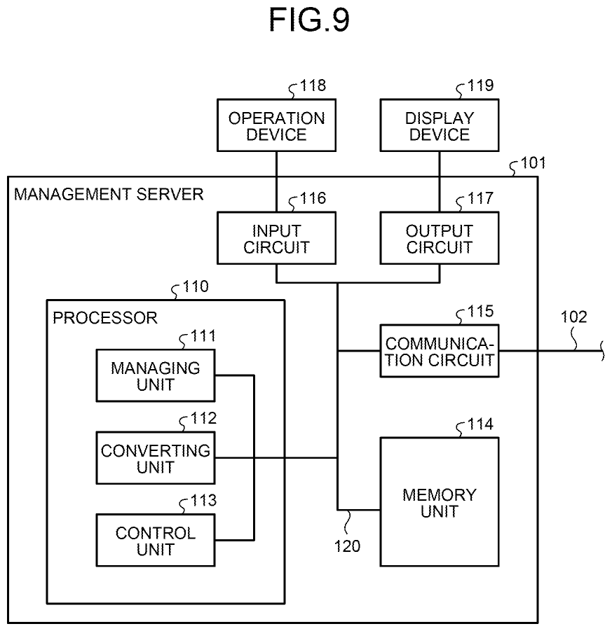

FIG. 9 is a diagram illustrating a configuration of the management server 101. For example, the management server 101 is a computer that includes a central processing unit (CPU) and a memory. The management server 101 includes a processor 110, a memory unit 114, a communication circuit 115, an input circuit 116, and an output circuit 117. The processor 110, the memory unit 114, the communication circuit 115, the input circuit 116, and the output circuit 117 are connected to each other via a bus 120. The processor 110 includes a managing unit 111, a converting unit 112, and a control unit 113 as the internal functional configuration.

The processor 110 is an electronic circuit that performs arithmetic processing and controls the management server 101. The processor 110 can be, for example, a CPU, a microprocessor, an ASIC, an FPGA, a PLD, or a combination thereof. The managing unit 111 provides an interface for enabling the user to operate the management server 101 via the terminal device 106. The interface provided by the managing unit 111 is, for example, an API, a CLI, or a webpage. For example, via the managing unit 111, the user inputs information about a combinatorial optimization problem, and browses and/or downloads the solution of the calculated combinatorial optimization problem. The converting unit 112 receives input of the parameters related to the combinatorial optimization problem, and converts the input parameters into a format that is processible in the compute servers 103. Moreover, the control unit 113 sends control commands to the compute servers 103. After the control unit 113 has obtained the computation results from the compute servers 103, the converting unit 112 summarizes a plurality of computation results, converts them into the solution of the combinatorial optimization problem, and outputs the solution of the combinatorial optimization problem.

The memory unit 114 is used to store: the programs meant for the management server 101; the data required for the execution of the programs; and a variety of data including the data generated by the programs. Herein, the programs include both OS and applications. Meanwhile, the memory unit 114 can be a volatile memory, a nonvolatile memory, or a combination thereof. A volatile memory is, for example, a DRAM or an SRAM. A nonvolatile memory is a NAND flash memory, a NOR flash memory, a ReRAM, or an MRAM. Alternatively, the memory unit 114 can be a hard disk, an optical disk, a magnetic tape, or an external storage device.

The communication circuit 115 transmits data to and receives data from various devices that are connected to the network 102. The communication circuit 115 is, for example, a Network Interface Card (NIC) for a wired LAN. Alternatively, the communication circuit 115 can be a communication circuit of some other type such as a communication circuit for a wireless LAN. The input circuit 116 enables data input to the management server 101. The input circuit 116 includes, for example, a USB or a PCI-Express as an external port. An operation device 118 is connected to the input circuit 116. The operation device 118 is used by the user to input information to the management server 101. Examples of the operation device 118 include, but are not limited to, a keyboard, a mouse, a touch-sensitive panel, and a sound recognition device. The output circuit 117 enables data output from the management server 101. The output circuit 117 includes HDMI (registered trademark) or DisplayPort as an external port. For example, A display device 119 is connected to the output circuit 117. Examples of the display device 119 include, but are not limited to, a Liquid Crystal Display (LCD), an organic electroluminescence (EL) display, and a projector.

The administrator can use the operation device 118 and the display device 119 and perform maintenance of the management server 101. The operation device 118 and the display device 119 can be integrated into the management server 101. However, the operation device 118 and the display device 119 need not be connected to the management server 101. For example, the administrator can perform maintenance of the management server 101 using a terminal device capable of communicating with the network 102.

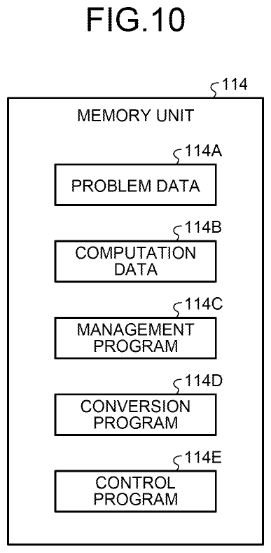

FIG. 10 is a diagram illustrating the data stored in the memory unit 114 of the management server 101. For example, the memory unit 114 is used to store problem data 114A, computation data 114B, a management program 114C, a conversion program 114D, and a control program 114E. The problem data 114A contains, for example, the data of combinatorial optimization problems. The computation data 114B contains, for example, the computation results collected from the compute servers 103. The management program 114C is meant for implementing, for example, the functions of the managing unit 111. The conversion program 114D is meant for implementing, for example, the functions of the converting unit 112. The control program 114E is meant for implementing, for example, the functions of the control unit 113.

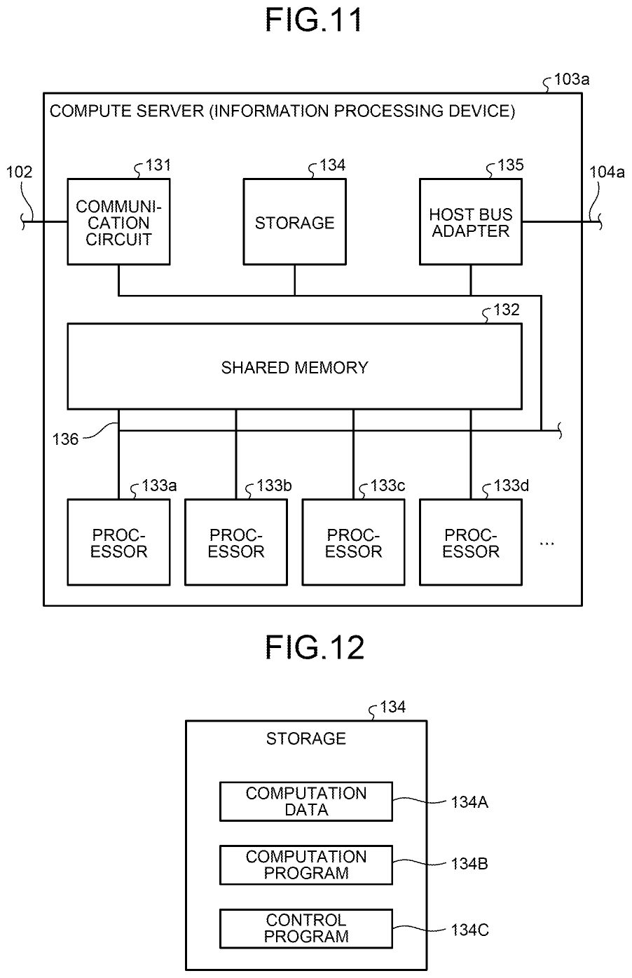

FIG. 11 is a diagram illustrating a configuration of the compute server 103a. The other compute servers 103 either can have an identical configuration to the compute server 103a, or can have a different configuration than the compute server 103a.

The compute server 103a includes, for example, a communication circuit 131, a shared memory 132, processors 133a to 133d, a storage 134, and a host bus adapter 135. The communication circuit 131, the shared memory 132, the processors 133a to 133d, the storage 134, and the host bus adapter 135 are connected to each other via a bus 136.

The communication circuit 131 transmits data to and receives data from the devices that are connected to the network 102. The communication circuit 131 is, for example, a Network Interface Card (NIC) for a wired LAN. Alternatively, the communication circuit 131 can be a communication circuit of some other type such as a communication circuit for a wireless LAN. The shared memory 132 is accessible from the processors 133a to 133d. The shared memory 132 is, for example, a volatile memory such as a DRAM and an SRAM. Alternatively, the shared memory 132 can be some other type of memory such as a nonvolatile memory. The processors 133a to 133d share data via the shared memory 132. Meanwhile, the shared memory 132 need not be configured using all of the memory of the compute server 103a. For example, some of the memory of the compute server 103a can be configured as a local memory accessible only from one of the processors 133a to 133d.

The processors 133a to 133d are electronic circuits that perform computation. Each of the processors 133a to 133d can be a CPU, a GPU, an FPGA, an ASIC, or a combination thereof. Alternatively, each of the processors 133a to 133d can be a CPU core or a CPU thread. When the processors 133a to 133d are CPUs, there is no particular restriction on the number of sockets provided in the compute server 103a. Meanwhile, the processors 133a to 133d can be connected to the other constituent elements of the compute server 103a via a bus such as a PCI express.

In the example illustrated in FIG. 11, the compute server 103a includes four processors 133a to 133d. However, in a single compute server 103a, the number of processors is not limited to four.

The storage 134 is used to store: the programs meant for the compute server 103a; data required for the execution of the programs; and a variety of data including the data generated by the programs. Herein, the programs include the OS and applications. Meanwhile, the storage 134 can be a volatile memory, a nonvolatile memory, or a combination thereof. A volatile memory is, for example, a DRAM or an SRAM. A nonvolatile memory is a NAND flash memory, a NOR flash memory, a ReRAM, or an MRAM. Alternatively, the storage 134 is a hard disk, an optical disk, a magnetic tape, or an external storage device.

The host bus adapter 135 performs data communication with the other compute servers 103. The host bus adapter 135 is connected to the switch 105 via the cable 104a. The host bus adapter 135 is, for example, a Host Channel Adaptor (HCA). The host bus adapter 135, the cable 104a, and the switch 105 constitute an interconnect capable of achieving a high throughput. That enables achieving enhancement in the speed of the parallel computation.

FIG. 12 is a diagram illustrating the data stored in the storage 134. The storage 134 is used to store, for example, computation data 134A, a computation program 134B, and a control program 134C. The computation data 134A contains the data obtained during the computation performed in the compute server 103a or contains the computation result. At least some of the computation data 134A can be stored in a different storage hierarchy such as the shared memory 132, the cache of the processor, or the register of the processor. The computation program 134B is meant for implementing the computation in each processor 133 and for implementing the operation of storing data in the shared memory 132 and the storage 134. The control program 134C is meant for controlling the compute server 103a based on a command sent from the control unit 113 of the management server 101, and sending the computation result of the compute server 103a to the management server 101.

In the compute server 103a, each of the processors 133a to 133d executes a program for solving a combinatorial optimization problem. The program causes the compute server 103a to function as the input unit 12, the updating unit 14, and the output unit 16.

The information processing system 100 configured in the manner explained above can be used as a PC cluster. A PC cluster is a system in which a plurality of computers is connected so as to achieve the computational performance not achievable in a single computer. In the information processing system 100, for example, a Message Passing Interface (MPI) can be used to ensure that, even when memories are disposed in a dispersed manner in a plurality of compute servers 103, it still becomes possible to perform parallel computation.

Meanwhile, the information processing system 100 can be configured as a plurality of GPUs connected by a high-speed link. In that case, each GPU performs identical operations to the operations performed by the compute servers 103.

Although the invention has been described with respect to the abovementioned specific embodiment for a complete and clear disclosure, the appended claims are not to be thus limited but are to be construed as embodying all modifications and alternative constructions that may occur to one skilled in the art that fairly fall within the basic teaching herein set forth. For example, some of the constituent elements described in the embodiments can be deleted. Alternatively, the constituent elements described in different embodiments can be appropriately integrated.

What is claimed is:

1. A solution finding device that solves a 0-1 combinatorial optimization problem under one or more constraint conditions that are expressed using inequality expressions in which a plurality of discrete variables included in the 0-1 combinatorial optimization problem is used, the solution finding device comprising:
a hardware processor configured to function as:
an updating unit that, for each of a plurality of elements associated with a first variable and a second variable, sequentially updates, for each unit time between initial timing and end timing, the first variable and the second variable alternatively; and
an output unit that outputs a solution of the 0-1 combinatorial optimization problem based on the first variable of each of the plurality of elements at the end timing, wherein
the plurality of elements correspond to the plurality of discrete variables,
each of the first variable and the second variable is expressed as a real number, and
during an updating operation performed for the each unit time,
for each of the plurality of elements, the updating unit updates the first variable based on the second variable,
for each of the plurality of elements, the updating unit updates the second variable based on the first variable, and
for each of the one or more constraint conditions, when the inequality expression in which the first variable corresponding to each of the plurality of discrete variables is substituted is not satisfied, the updating unit subtracts, from the second variable of each of the plurality of elements, a correction value that corresponds to a component of an element corresponding to a distance from a boundary of the inequality expression to positions identified by the plurality of elements.

2. The solution finding device according to claim 1, wherein
for each of the plurality of elements at the end timing, the output unit calculates a value of a discrete variable by binarizing the first variable using a preset threshold value, and
the output unit outputs calculated values of the plurality of discrete variables as the solution of the 1-0 combinatorial optimization problem.

3. The solution finding device according to claim 2, wherein, during the updating operation performed for the each unit time, for each of the plurality of elements, the updating unit
updates the first variable and then updates the second variable, and
after updating the second variable, subtracts the correction value from the second variable.

4. The solution finding device according to claim 2, wherein, during the updating operation performed for the each unit time, for each of the plurality of elements, the updating unit
updates the second variable and then updates the first variable, and
after updating the second variable and before updating the first variable, subtracts the correction value from the second variable.

5. The solution finding device according to claim 2, wherein, during the updating operation for the each unit time, for each of the plurality of elements, the updating unit calculates the first variable at target timing by adding, to the first variable at immediately previous timing earlier than the target timing by an amount of time equal to a unit time, a value obtained by multiplying the second variable, a predetermined constant number, and the unit time.

6. The solution finding device according to claim 5, wherein, during the updating operation performed for the each unit time, for each of the plurality of elements, the updating unit
calculates an external force based on
the first variable of each of the plurality of elements, and
an action coefficient set according to the 0-1 combinatorial optimization problem for each pair of target element and each of the plurality of elements,
calculates a time evolution value by multiplying a value decided based on a function that increases over time and the first variable of the target element, and
adds, to the second variable at the immediately previous timing, a value obtained by multiplying the unit time and a value to which the time evolution value and the external force are added, and calculates the second variable at the target timing.

7. The solution finding device according to claim 6, wherein
the 0-1 combinatorial optimization problem includes N number of discrete variables, and
for an i-th element corresponding to an i-th discrete variable from among the N number of discrete variables, the updating unit calculates the first variable at the target timing according to Formula (101) and Formula (102),
xᵢ(t+Δt)=xᵢ(t)+Dyᵢ(t)Δ (101)
xᵢ(t+Δt)=xᵢ(t30 Dyᵢ(t+Δt)Δt (102)
where, N represents an integer equal to or greater than 2,
i represents an integer from 1 to N,
D represents the constant number,
Δt represents the unit time,
t represents the immediately previous timing,
t+Δt represents the target timing,
xᵢ(t) represents the first variable at the immediately previous timing for the i-th element,
yᵢ(t) represents the second variable at the immediately previous timing for the i-th element,
xᵢ(t+Δt) represents the first variable at the target timing for the i-th element, and
yᵢ(t+Δt) represents the second variable at the target timing for the i-th element.

8. The solution finding device according to claim 7, wherein
the 0-1 combinatorial optimization problem is a 0-1 quadratic programming problem, and
the updating unit calculates the second variable at the target timing for the i-th element according to Formula (103) or Formula (104),
yᵢ(t+Δt)=yᵢ(t)+{gᵢ(t+Δt)+fᵢ(t+Δt)}Δt (103)
yᵢ(t+Δt)=yᵢ(t)+{gᵢ(t)+fᵢ(t)}Δt (104)
where, gᵢ(t) and gᵢ(t+Δt) represent the time evolution value,
fᵢ(t+Δt) is expressed according to Formula (105) and fᵢ(t) is expressed according to Formula (106),
fᵢ(t+Δt)=−czᵢ(t+Δt) (105)
fᵢ(t)=−czᵢ(t) (106)
where, zᵢ(t+Δt) is expressed according to Formula (107), and
zᵢ(t) is expressed according to Formula (108),
$${z}_{i} ( t + Δ t ) = - {h}_{i} α ( t + Δ t ) - {\sum }_{j = 1}^{N} {J}_{i , j} {x}_{j} ( t + Δ t ) \qquad ( 107 )$$
$${z}_{i} ( t ) = - {h}_{i} α ( t ) - {\sum }_{j = 1}^{N} {J}_{i , j} {x}_{j} ( t ) \qquad ( 108 )$$
where, j represents an integer from 1 to N,
hᵢ represents an i-th local magnetic field coefficient included in a predetermined array including N number of local magnetic field coefficients,
J_{i, j} represents a coupling coefficient of an i-th row and an j-th column in a predetermined matrix including N×N number of coupling coefficients,
c represents a predetermined real number,
xⱼ(t) represents the first variable at the immediately previous timing for a j-th element that corresponds to a j-th discrete variable from among the N number of discrete variables,
xⱼ(t+Δt) represents the first variable at the target timing for the j-th element, and
α(t) represents a predetermined function having t as an argument.

9. The solution finding device according to claim 8, wherein
gᵢ(t) is expressed according to Formula (109), and
gᵢ(t+Δt) is expressed according to Formula (110),
gᵢ(t+Δt)={−D+p(t+Δt)−Kxᵢ²(t+Δt)}xᵢ(t+Δt) (109)
gᵢ(t)={−D+p(t)−Kxᵢ²(t)}xᵢ(t) (110)
where, p(t) represents a predetermined function that has t as an argument, that increases according to t, that becomes 0 at the initial timing of t, and that becomes 1 at the end timing of t, and
K represents a predetermined constant number.

10. The solution finding device according to claim 8, wherein
from among the one or more constraint conditions, a m-th constraint condition is expressed according to Formula (111),
$${\sum }_{i = 1}^{N} {ω}_{m , i} {x}_{i} ≦ {W}_{m} \qquad ( 111 )$$
where, m represents an integer equal to or greater than 1,
xᵢ represents the i-th discrete variable,
ω_{m, i} represents a coefficient multiplied to the i-th discrete variable, and
Wₘ represents a predetermined constant number.

11. The solution finding device according to claim 10, wherein the updating unit calculates r_{m, i} expressed according to Formula (112), as the correction value with respect to the second variable of the i-th element,
r_{m,i}=Δt·Aₘ·k·|Sₘ−Wₘ|^{k-1}·ω_{m,i} (112)
where, Aₘ represents a coefficient that is predetermined with respect to the m-th constraint condition,
k represents one or more predetermined integers, and
Sₘ is expressed according to Formula (113) or Formula (114)
$${S}_{m} = {\sum }_{i = 1}^{N} {ω}_{m , i} \cdot {x}_{i} ( t + Δ t ) \qquad ( 113 )$$
$${S}_{m} = {\sum }_{i = 1}^{N} {ω}_{m , i} \cdot {x}_{i} ( t ) . \qquad ( 114 )$$

12. The solution finding device according to claim 10, wherein the updating unit calculates r_{m, i} expressed according to Formula (115), as the correction value with respect to the second variable of the i-th element,
r_{m,i}=Δt·(Aₘ·k·|Sₘ−Wₘ|^{k-1}·ω_{m,i}+Bₘ·Eₘ) (115)
where, Aₘ represents a coefficient that is predetermined with respect to the m-th constraint condition,
k represents one or more predetermined integers, and
Sₘ is expressed according to Formula (116) or Formula (117),
$${S}_{m} = {\sum }_{i = 1}^{N} {ω}_{m , i} \cdot {x}_{i} ( t + Δ t ) \qquad ( 116 )$$
$${S}_{m} = {\sum }_{i = 1}^{N} {ω}_{m , i} \cdot {x}_{i} ( t ) \qquad ( 117 )$$
where, Bis a value equal to or greater than 0 and equal to or smaller than 1, and represents a coefficient that is predetermined with respect to the m-th constraint condition, and
Eₘ is expressed according to Formula (118)
$${E}_{m} = {\sum }_{i = 1}^{N} {ω}_{m , i} \cdot {y}_{i} ( t + Δ t ) . \qquad ( 118 )$$

13. The solution finding device according to claim 8, wherein, from among the one or more constraint conditions, one constraint condition is expressed according to Formula (119),
$${\sum }_{i = 1}^{N} {\sum }_{j = 1}^{N} {Q}_{i , j} \cdot {x}_{i} \cdot {x}_{j} ≦ q \qquad ( 119 )$$
where, xᵢ represents the i-th discrete variable,
xⱼ represents the j-th discrete variable,
Q_{i,j} represents a value at an i-th row and a j-th column included in a positive-semidefinite matrix, and
q represents a predetermined constant number.

14. The solution finding device according to claim 13, wherein the updating unit calculates rᵢ expressed according to Formula (120) or Formula (121), as the correction value with respect to the second variable of the i-th element,
$${r}_{i} = Δ t \cdot A \cdot k \cdot {\vert S - q \vert}^{k - 1} \cdot 2 \cdot {\sum }_{j = 1}^{N} {Q}_{i , j} \cdot x ( t + Δ t ) \qquad ( 120 )$$
$${r}_{i} = Δ t \cdot A \cdot k \cdot {\vert S - q \vert}^{k - 1} \cdot 2 \cdot {\sum }_{j = 1}^{N} {Q}_{i , j} \cdot x ( t ) \qquad ( 121 )$$
where, A represents a coefficient that is predetermined with respect to a corresponding constraint condition,
k represents one or more predetermined integers, and
S is expressed according to Formula (122) in a case of Formula (120) and is expressed according to Formula (123) in a case of Formula (121)
$$S = {\sum }_{i = 1}^{N} {\sum }_{j = 1}^{N} {Q}_{i , j} \cdot {x}_{i} ( t + Δ t ) \cdot {x}_{j} ( t + Δ t ) \qquad ( 122 )$$
$$S = {\sum }_{i = 1}^{N} {\sum }_{j = 1}^{N} {Q}_{i , j} \cdot {x}_{i} ( t ) \cdot {x}_{j} ( t ) . \qquad ( 123 )$$

15. A solution finding method that is implemented by a computer of an information processing device for solving a 0-1 combinatorial optimization problem under one or more constraint conditions that are expressed using inequality expressions in which a plurality of discrete variables included in the 0-1 combinatorial optimization problem is used, the solution finding method comprising:
an updating step that, by the information processing device, for each of a plurality of elements associated with a first variable and a second variable, sequentially updates, for each unit time between initial timing and end timing, the first variable and the second variable alternatively; and
an outputting step that, by the information processing device, outputs a solution of the 0-1 combinatorial optimization problem based on the first variable of each of the plurality of elements at the end timing, wherein
the plurality of elements correspond to the plurality of discrete variables,
each of the first variable and the second variable is expressed as a real number, and
during the updating step implemented for the each unit time,
for each of the plurality of elements, the first variable is updated based on the second variable,
for each of the plurality of elements, the second variable is updated based on the first variable, and
for each of the one or more constraint conditions, when the inequality expression in which the first variable corresponding to each of the plurality of discrete variables is substituted is not satisfied, from the second variable of each of the plurality of elements, a correction value is subtracted, the correction value corresponding to a component of an element corresponding to a distance from a boundary of the inequality expression to positions identified by the plurality of elements.

16. A computer program product having a non-transitory computer readable medium including programmed instructions that cause an information processing device to function as a solution finding device solving a 0-1 combinatorial optimization problem under one or more constraint conditions that are expressed using inequality expressions in which a plurality of discrete variables included in the 0-1 combinatorial optimization problem is used, the instructions causing the information processing device to function as:
an updating unit that, for each of a plurality of elements associated with a first variable and a second variable, sequentially updates, for each unit time between initial timing and end timing, the first variable and the second variable alternatively; and
an output unit that outputs a solution of the 0-1 combinatorial optimization problem based on the first variable of each of the plurality of elements at the end timing, wherein
the plurality of elements correspond to the plurality of discrete variables,
each of the first variable and the second variable is expressed as a real number, and
during an updating operation performed for the each unit time,
for each of the plurality of elements, the updating unit updates the first variable based on the second variable,
for each of the plurality of elements, the updating unit updates the second variable based on the first variable, and
for each of the one or more constraint conditions, when the inequality expression in which the first variable corresponding to each of the plurality of discrete variables is substituted is not satisfied, the updating unit subtracts, from the second variable of each of the plurality of elements, a correction value that corresponds to a component of an element corresponding to a distance from a boundary of the inequality expression to positions identified by the plurality of elements.
